(19) United States
(12) Patent Application Publication
(10) Pub. No.: US 2014/0169129 A1
(43) Pub. Date: Jun. 19, 2014

(54) Downhole Receiver Systems and Methods for Low Frequency Seismic Investigations

(71) Applicant: SCHLUMBERGER TECHNOLOGY CORPORATION, (US)

(72) Inventor: Jacques Orban, Gloucestershire (GB)

(73) Assignee: SCHLUMBERGER TECHNOLOGY CORPORATION, Sugar Land, TX (US)

(21) Appl. No.: 13/719,081

(22) Filed: Dec. 18, 2012

(51) Int. Cl. G01V 1/40

(52) U.S. Cl. CPC G01V 1/40
USPC 367/25

(57) ABSTRACT

Downhole seismic receiver systems that may be compatible with measurement-while-drilling systems. The downhole seismic receiver systems may be integrated into drill-string components, including drill collars of a bottom hole assembly. The downhole seismic receiver systems include one or more receiver subsystems which in turn include at least two or more same-type seismic sensors. The downhole seismic receiver systems are compatible with low frequency seismic sources and may be useful in determining orientation and location of bed boundaries around a wellbore and ahead of a drill-bit. The downhole seismic receiver systems can be operated with a downhole or surface source. Methods for downhole seismic, including single well and cross-well seismic. The methods may include analyzing data acquired by the receiver systems to obtain seismic information around the wellbore and ahead of the drill bit.

### FIELD

The present disclosure relates to the study of underground formations and structures, for example as it relates to oil and gas exploration. The present disclosure relates more specifically to seismic surveying of subterranean geological formations.

### BACKGROUND

Borehole seismic investigation is of interest to oil and gas exploration professionals because it can provide a deeper view into a formation than other available investigation techniques. However, current borehole seismic methods can face limitations in their implementation. For example, borehole seismic survey systems may involve sources located at the surface and receivers placed in the well. Other configurations may be possible, for example the drill bit can function as the seismic source and receivers can be placed at the surface. In either case, the distance between source and receivers can result in attenuation and loss of resolution. Wireline borehole seismic is another method involving receivers in the wellbore and the source at surface. A benefit of seismic application with receivers at known depth in the wellbore and source at the surface is the capability of performing accurate conversion of the time data into depth information.

### SUMMARY

The present disclosure provides systems and methods for borehole seismic investigations, including low frequency systems and methods for acquiring images around a wellbore and ahead of a drill bit.

In some embodiments, the systems are seismic receiver systems for gathering data from low frequency seismic signals (for example ranging up to about 500 Hz, or even up to about 700 Hz when including harmonics from transmitted signal, or from about 10 Hz to about 400 Hz, or from about 10 Hz to about 250 Hz, or from about 10 Hz to about 100 Hz, or from about 7 Hz to about 80 Hz, or from about 25 Hz to about 250 Hz) in order to estimate the inclination and/or the tool-face of reflectors in a surrounding formation relative to a drill-string tubular, the distance between the tubular and a reflector in the formation, or combinations thereof. In some embodiments, the seismic systems can be built into the drilling tubular. Several seismic receiver subsystems may be included in a drilling system to constitute a seismic receiver system (or seismic antenna). The receiver subsystems can include at least two seismic sensors of same type, for example, at least two hydrophones, or at least two geophones, or at least two accelerometers, which sensors are affixed to a drill-string tubular and may be axially spaced-apart from one another.

When multiple receiver subsystems are used in the drilling tubular, the distance between receiver subsystems can be chosen to facilitate a depth of view into the surrounding formation ranging up to about 500 m (or from up to about 200 m to about 400 m). Accordingly, in some embodiments, the most distant subsystems may be separated by about 500 m. In some embodiments of seismic receiver network, the axial distance between each receiver subsystem is measured from the center of one subsystem to the center of a neighboring subsystem and can range from about 1λ (wavelength) to about 5λ, where the wavelength can correspond to the mean frequency contained in the transmitted signal. In some embodiments, the distance between center points of adjacent receiver subsystems can range from about 10 m to about 100 m, or from about 30 m to about 70 m. In some embodiments, the axial distance between seismic sensors within a receiver subsystem can be chosen to facilitate recognition of a similar signal shifted by a small delta-time versus arrival time. In some embodiments, the distance between receivers within a subsystem can range from about 3 m to about 10 m.

In some embodiments of seismic receiver network, each receiver subsystem can include at least two same-type seismic sensors, such as at least two multi-component geophones (for example at least two 2C geophones or at least 2 pairs of geophones with different orientations, for example 90 degrees from each other, or at least two 3C geophones, or at least one 2C geophone and at least one 3C geophone), at least two multi-component accelerometers (for example at least two 2C accelerometers, or at least two 3C accelerometers, or at least one 2C accelerometer and at least one 3C accelerometer), at least two hydrophones or combinations thereof. In further embodiments, each sensor corresponding to the same-type sensors is axially distributed along a drill-string tubular.

In some embodiments, a receiver subsystem can be integrated into a single drill-string tubular and the distance between sensors in a given subsystem can therefore be constrained by the length of the tubular (which is on the order of about 10 meters for conventional tubulars). In further embodiments, two to four same-type seismic sensors can be substantially uniformly distributed over the length of the tubular. In some embodiments, the receiver subsystem can include either two 3C geophones (or 3C accelerometers), or two 2C geophones (or 2C accelerometers), and two or three or four hydrophones, where the geophones (or accelerometers) are axially spaced apart from one another along a central tool body, and the hydrophones are axially spaced apart from one another along the drill-string tubular. In further embodiments, the receiver subsystem can be integrated into a drill-string tubular which has one, two, or more flex joints, for example, two flex joints flanking the central tool body.

In some embodiments, the receiver subsystem can also include a device, such as a stabilizer or a coupling pad assembly for coupling the geophones, for example the first and second multi-component geophones (or accelerometers) to the formation. In some embodiments, the receiver subsystem can be equipped with detectors designed to determine the orientation of the seismic receiver subsystem versus the earth's gravity vector and/or the earth's magnetic vector. These orientation measurements may be used to perform vectorial rotation of the seismic measurements acquired by multi-component geophones (or accelerometers) in order to rotate those measurements into a common system of reference axes (such as Vertical axis, North Axis and East axis) so that all seismic data corresponding to one axis can be processed together to form consistent images.

In some embodiments, the seismic receiver network can also include one or more of a clock synchronization system and a data management system. The data management system may be associated with a communication system: for example to transmit the data to surface via a cable based communication system such as a wireline system or a wired-drill-pipe telemetry system; or, for example, to transmit the data via a local downhole network to a downhole central unit, for transmitting some or all of the data to the surface; or, for example, the data management system may include a data reduction system to identify a subset of reflectors in order to transmit only that subset of information to the surface (for example via the local network). In some embodiments, the data reduction system is a semblance analysis process. In some embodiments, the receiver subsystem can include: a stabilizer, and/or a detector for determining the orientation of the tubular and the receiver subsystem.

The disclosure also provides methods for gathering data relating to low frequency seismic signals for seeing around the wellbore and/or ahead of the drill bit, among other possibilities. In some embodiments, the methods can involve using a downhole network of receiver subsystems to gather data relating to low frequency seismic signals ranging up to about 500 Hz, even up to about 700 Hz, or up to about 400 Hz, or from about 100 Hz to about 250 Hz; and estimating at least one of: the inclination of a drill-string tubular versus a reflector in a formation, the tool-face of the reflector in the formation around the wellbore, the distance between the drill-string tubular and a reflector in the formation, and combinations thereof, from the gathered data. In some embodiments, the receiver systems can include two or more, for example two to four subsystems, and each receiver subsystem can include at least two axially spaced-apart, same-type seismic sensors. In some embodiments, the distance between adjacent receiver subsystems can range from about 10 m to about 100 m, and the distance between seismic sensors within a subsystem can range from about 3 m to about 10 m.

In some embodiments, the methods can further include transmitting the data to the surface. In some embodiments, the data can be transmitted using wired-drill-pipe telemetry. In some embodiments, the data can be transmitted using an MWD system. In some embodiments, the methods can include first reducing the data, for example using downhole processing such as semblance analysis, to identify a subset of reflectors before transmitting the data to the surface.

The identified embodiments are exemplary only and are therefore non-limiting. The details of one or more non-limiting embodiments of the disclosure are set forth in the accompanying drawings and the descriptions below. Other embodiments of the disclosure should be apparent to those of ordinary skill in the art after consideration of the present disclosure.

### BRIEF DESCRIPTION OF DRAWINGS

FIG. 1 is a partial schematic representation of an exemplary apparatus for measurement while drilling that is compatible with the devices, systems and methods of this disclosure.

FIG. 2 is a schematic illustration of expected wave propagation for systems having surface seismic sources.

FIG. 3 is a schematic illustration of expected wave propagation for systems having downhole seismic sources.

FIG. 4 is a schematic illustration of an embodiment of a receiver subsystem in accordance with this disclosure.

FIG. 5 is a schematic illustration of construction of hydrophone pairs around a tubular for detecting propagation direction of seismic waves.

FIG. 6 is a representation of signal output of hydrophone pairs illustrated in FIG. 5.

FIG. 7 is schematic illustration of characteristics of geophone coupling to formation.

FIG. 8 is a representation of output of radial and tangent geophones in relation to the coupling characteristics of FIG. 7.

FIG. 9 is a partial schematic illustration of a wellbore fitted with a tubular configured with geophones and an embodiment of a geophone coupling device according to this disclosure.

FIG. 10 is a cross-sectional schematic illustration of the tubular of FIG. 4 further illustrating potential tubular oscillation in the borehole

FIG. 11 is a partial schematic illustration of a wellbore fitted with a tubular embodiment configured with a defined point of coupling for a geophone.

FIG. 12 is a cross-sectional schematic illustration of the embodiment of FIG. 11.

FIG. 13 is a cross-sectional schematic illustration of the tubular of FIG. 11 further illustrating potential tubular oscillation in the borehole for specific orientations.

FIG. 14 is a schematic illustration of a geophone coupling device in accordance with this disclosure.

FIG. 15 is a schematic illustration of a geophone coupling device in accordance with this disclosure.

FIG. 16a is a schematic illustration of an embodiment of a receiver subsystem in accordance with this disclosure and FIG. 16b is a cross-sectional schematic view of the embodiment of FIG. 16a.

FIG. 17 is a schematic representation of reflected ray paths from a downhole source to a receiver system.

FIG. 18 is a schematic representation of reflected ray paths from a downhole source to a receiver system, with relation between incident angle at receiver, dip angle and distances to reflector and source.

FIG. 19 is a representation of reflector tool-face issue and solution.

FIG. 20 is a representation of two potential tool-faces for a reflector and solution to the problem.

FIG. 21 is an illustration of a unique position of a reflector versus wellbore for a given dip and tool-face and distance.

FIG. 22 describes “semblance processing.”

FIG. 23 is an example of a semblance analysis map, which may be generated from data collected by the receiver subsystem of FIG. 4.

FIG. 24 illustrates a reflector mapping versus wellbore reference point.

### DETAILED DESCRIPTION

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrases “for example,” “such as,” “including” and the like are used herein, the phrase “and without limitation” is understood to follow unless explicitly stated otherwise. Therefore, “for example a mud turbine generator” means “for example and without limitation a mud turbine generator.”

The terms “comprising” and “including” and “involving” (and similarly “comprises” and “includes” and “involves”) are used interchangeably and mean the same thing. Specifically, each of the terms is defined consistent with the common United States patent law definition of “comprising” and is therefore interpreted to be an open term meaning “at least the following” and also interpreted not to exclude additional features, limitations, aspects, etc.

The term “about” is meant to account for variations due to experimental error. The term “substantially” is meant to permit deviations from the descriptive term that don't negatively impact the intended purpose. All measurements or numbers are implicitly understood to be modified by the word about, even if the measurement or number is not explicitly modified by the word about. All descriptive terms are implicitly understood to be modified by the word substantially, even if the descriptive term is not explicitly modified by the word substantially.

The terms “wellbore” and “borehole” are used interchangeably.

The phrases “seismic receiver system,” “network of seismic receiver subsystems,” “receiver system” and “network of receiver subsystems” are used interchangeably.

The phrases “receiver subsystem,” “seismic receiver subsystem,” “receiver sub” and “seismic receiver sub” are used interchangeably.

“Tubular” and “drill-string tubular” are used interchangeably.

“Measurement While Drilling” (“MWD”) can refer to devices for measuring downhole conditions including the location of the drilling assembly contemporaneously with the drilling of the well as well as providing telemetry to surface. “Logging While Drilling” (“LWD”) can refer to devices concentrating more on the measurement of formation parameters. While distinctions may exist between these terms, they are also often used interchangeably. Both terms are understood as related to the collection of downhole information generally, to include, for example, both the collection of information relating to the movement and position of the drilling assembly and the collection of formation parameters.

The terms “connected,” “attached,” “affixed” or the like are understood to be modified by “directly or indirectly.” In other words, if A is attached to B, it may be directly attached to B or indirectly attached to B through additional components.

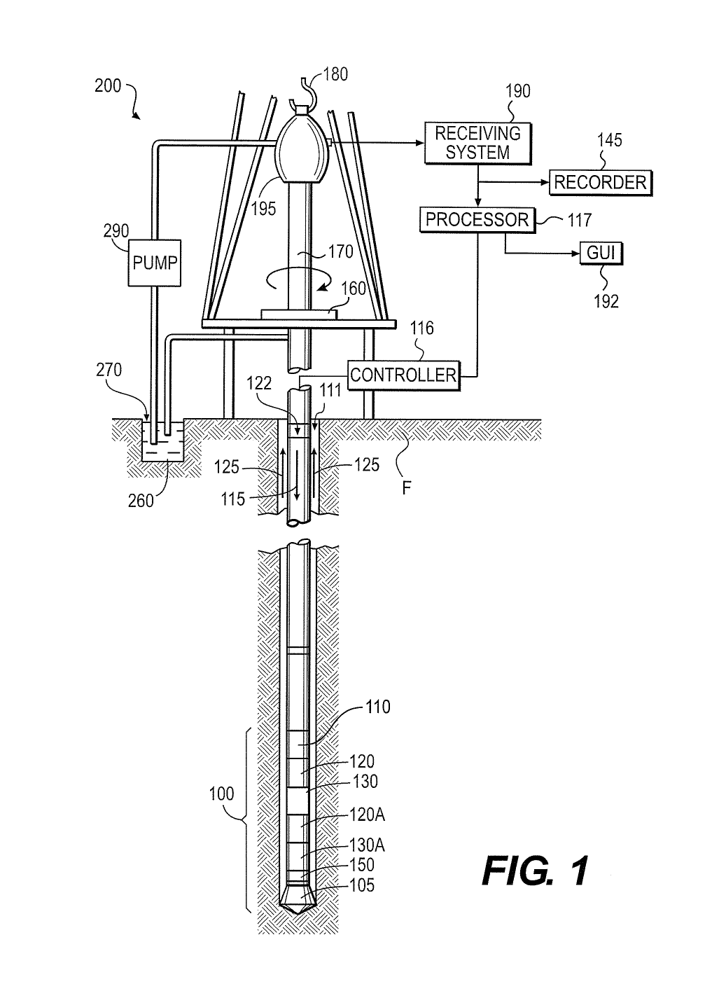

FIG. 1 illustrates a non-limiting, exemplary well logging system used to obtain well data and other information during drilling process, in which may be integrated receiver subsystems and/or network of seismic receiver subsystems in accordance with embodiments of the present disclosure.

FIG. 1 illustrates a land-based platform and derrick assembly (drilling rig) 200 and drill string 122 with a well data acquisition and logging system, positioned over a wellbore 111 for exploring a formation F. In the illustrated embodiment, the wellbore 111 is formed by rotary drilling. Those of ordinary skill in the art given the benefit of this disclosure will appreciate, however, that the subject matter of this disclosure also finds application in directional drilling applications as well as rotary drilling, and is not limited to land-based rigs.

The drill string 122 is suspended within the wellbore 111 and includes a drill bit 105 at its lower end. The drill string 122 is rotated by a rotary table 160, energized by means not shown, which engages a kelly 170 at the upper end of the drill string 122. The drill string 122 is suspended from a hook 180, attached to a travelling block (also not shown), through the kelly 170 and a rotary swivel 195 which permits rotation of the drill string 122 relative to the hook 180.

Drilling fluid or mud 260 is stored in a pit 270 formed at the well site. A pump 290 delivers the drilling fluid 260 to the interior of the drill string 122 via a port in the swivel 195, inducing the drilling fluid 260 to flow downwardly through the drill string 122 as indicated by the directional arrow 115. The drilling fluid 260 exits the drill string 122 via ports in the drill bit 105, and then circulates upwardly through the region between the outside of the drill string 122 and the wall of the wellbore, called the annulus, as indicated by the direction arrows 125. In this manner, the drilling fluid 260 lubricates the drill bit 105 and carries formation cuttings up to the surface as it is returned to the pit 270 for recirculation.

The drill string 122 further includes a bottom hole assembly (“BHA”), generally referred to as 100, near the drill bit 105 (for example, within several drill collar lengths from the drill bit). The BHA 100 includes capabilities for measuring, processing, and storing information, as well as communicating with the surface. The BHA 100 thus may include, among other things, one or more logging-while-drilling (“LWD”) modules 120, 120A and/or one or more measuring-while-drilling (“MWD”) modules 130, 130A. The BHA 100 may also include a rotary-steerable system and/or motor 150.

The LWD and/or MWD modules 120, 120A, 130, 130A can be housed in a drill collar, and can contain one or more types of logging tools for investigating well drilling conditions or formation properties. The logging tools may provide capabilities for measuring, processing, and storing information, as well as for communication with surface equipment.

The BHA 100 may also include a surface/local communications subassembly 110, which may be configured to enable communication between the tools in the LWD and/or MWD modules 120, 120A, 130, 130A and processors at the earth's surface. For example, the subassembly 110 may include a telemetry system that includes an acoustic transmitter that generates an acoustic signal in the drilling fluid (a.k.a. “mud pulse”) that is representative of measured downhole parameters. The acoustic signal is received at the surface by instrumentation that can convert the acoustic signals into electronic signals. For example, the generated acoustic signal may be received at the surface by transducers. The output of the transducers may be coupled to an uphole receiving system 190, which demodulates the transmitted signals. The output of the receiving system 190 may be coupled to a computer processor 117 and a recorder 145. The computer processor 117 may be coupled to a monitor, which employs graphical user interface (“GUI”) 192 through which the measured downhole parameters and particular results derived therefrom are graphically or otherwise presented to the user. In some embodiments, the data is acquired real-time and communicated to the back-end portion of the data acquisition and logging system. In some embodiments, the well data may be acquired and recorded in the memory in downhole tools for later retrieval.

The LWD and MWD modules 120, 120A, 130, 130A may also include an apparatus for generating electrical power to the downhole system. Such a power generator may include, for example, a mud turbine generator powered by the flow of the drilling fluid, but other power and/or battery systems may be employed additionally or alternatively.

The well-site system is also shown to include an electronics subsystem having a controller 116 and a processor 117, which may optionally be the same processor used for analyzing logging data and which together with the controller 116 can serve multiple functions. For example, the controller 116 and processor 117 may be used to power and operate the logging tools such as the seismic investigation tool mentioned below. The controller and processor need not be on the surface as shown but may be configured in any suitable way. For example, alternatively, or in addition, the controller and/or processor may be part of the MWD (or LWD) modules or part of the drill string carrying the seismic investigation tool or seismic sources or seismic receiver subsystems.

In some embodiments of the devices, methods and systems according to this disclosure, the electronics subsystem (whether located on the surface or sub-surface on or within the tool or some combination thereof) includes one or more of clock synchronization protocols, machine-readable instructions for data reduction in advance of transmission, and machine-readable instructions for analyzing the distance and orientation of one or more bed boundaries from data collected by seismic receiver subsystems according to this disclosure and in response to seismic signals generated by seismic vibrators.

The disclosure provides downhole receiver systems, which may include a single receiver subsystem or multiple receiver subsystems, for gathering low frequency seismic data. In some embodiments, the downhole receiver systems are compatible with seismic-while-drilling (“SWD”) systems, for example measurement-while-drilling (“MWD”) systems. For example, the downhole receiver system, optionally along with the seismic source, can be integrated into drill-string components. For example, the receiver systems can be integrated into drill-string tubulars and the seismic source can be integrated into the drill collar or bottom hole assembly. In some embodiments, the downhole receiver systems are configured to gather data generated when a seismic source generating a range of low frequency signals (a sweep wave) suitable for imaging ahead of the drill bit is fired. In some embodiments, the downhole receiver systems gather data resulting from seismic sources which produce signals ranging up to about 700 Hz (when including harmonics from transmitted signal), or up to about 500 Hz, or from about 10 Hz to about 400 Hz, or from about 10 Hz to about 250 Hz, or from about 10 Hz to about 100 Hz, or from about 7 Hz to about 80 Hz), or from about 25 Hz to about 250 Hz. A non-limiting exemplary source for use with the downhole receiver systems is described in a co-pending application, filed concurrently herewith, also assigned to Schlumberger, and entitled: “Devices, Systems, and Methods for Low Frequency Seismic Borehole Investigations.” The referenced co-pending source application is incorporated by reference in its entirety herewith.

According to some embodiments, the network of receiver subsystems are configured to gather data, which facilitate determining the distance and orientation of bed boundaries, including ahead of the drill bit. In some embodiments, the network of subsystems are configured to facilitate viewing up to about 200 m, or up to about 300 m, or up to about 400 m, or up to about 500 m away from the wellbore in which the seismic receiver system is installed.

In some embodiments, the network of receiver subsystems further include an electronics subsystem having data processing capabilities for determining the distance and/or orientation of at least a portion of the reflectors (bed boundaries) near the seismic system (for example up to about 500 m around the wellbore and/or ahead of the drill bit.) In some embodiments, the receiver systems further include a data management subsystem for optional local data processing, optional downhole data storage, and managing transfer (telemetry) of data to other downhole equipment and even to the surface via an optional telemetry repeater. The data transfer (telemetry) can be performed, for example, via wired-drill-pipe as telemetry for transferring collected data to the surface. In some embodiments, the data transfer from the receiver system is transferred to a downhole processing unit which can perform more data reduction and itself organize the data transfer to surface via MWD telemetry. Non-limiting examples of telemetry systems include those described in the following patents and applications, each of which is herein incorporated by reference in their entirety: “System and Method for Wirelessly Communicating with a Downhole Drill String”, U.S. Pat. No. 7,598,886; “Wired Tool String Component”, U.S. Pat. No. 7,382,273; “Wired Tool String Component”, U.S. Pat. No. 7,535,377; “Wired Tool String Component”, U.S. application Ser. No. 12/432,231; “Downhole Coils”, U.S. application Ser. No. 11/860,761; “Downhole Coils”, U.S. application Ser. No. 11/860,795. In some embodiments, the data management subsystem includes a data reduction system or process for reducing the volume of data transmitted to the surface. For example, the data reduction subsystem may identify a subset of reflectors and only data relating to that subset of reflectors is transmitting to the surface. In some embodiments, the systems are configured for drill-string application, for example MWD drill-string applications.

The disclosure also provides methods for downhole seismic, including single well and cross-well seismic. In some embodiments, the methods include acquiring data relating to low frequency seismic investigations such as acquiring data relating to signals generated from an impulse source or sweep waves encompassing frequencies ranging up to about 500 Hz, or up to about 700 Hz when including the harmonic from the transmitted signal, or from about 10 Hz to about 400 Hz, or from about 10 Hz to about 250 Hz, or from about 10 Hz to about 100 Hz, or from about 7 Hz to about 80 Hz, or from about 25 Hz to about 250 Hz. In some embodiments, where a downhole source is used, the methods can include acquiring data relating to the higher of the afore-mentioned frequency ranges. In some embodiments, where a surface source is used, the methods can include acquiring data relating to the lower of the afore-mentioned frequency ranges, as the transmission path is longer with higher associated attenuation (for example for the high frequency content). In some embodiments, the methods include obtaining seismic information ahead of the drill bit, for example up to about 200 m or up to about 300 m or up to about 400 m or up to about 500 m in depth. In some embodiments, the methods include obtaining seismic information around the wellbore at a depth similar to the receiver system, for example up to about 200 m, or up to about 300 m, or up to about 400 m, or up to about 500 m inside the surrounding formation of the wellbore. In some embodiments, the methods further include a data reduction step, for example to reduce the volume of data prior to transmission to the surface, such as a semblance analysis step, which includes seismic data between adjacent receivers inside a small shifted time window along the recorded data and may detect the signal for the corresponding reflectors, even in the case of a signal arriving at various incident angles onto the receiver subsystem. Semblance analysis is described in a co-pending application, filed concurrently herewith, also assigned to Schlumberger, and entitled: “DATA PROCESSING SYSTEMS AND METHODS FOR DOWNHOLE SEISMIC INVESTIGATIONS.” The referenced co-pending signal processing application is hereby incorporated by reference in its entirety herewith.

### Receiver Systems (Network of Receiver Subsystems).

The downhole seismic receiver systems according to this disclosure include at least one receiver subsystem. In general, in some embodiments, the downhole receiver systems are designed to fit in a tubular system lowered into a well. In some embodiments, the receiver systems can be optimized for incorporation into a bottom hole assembly (“BHA”) for drilling wells for oil and gas applications.

In some embodiments, at least two receiver subsystems, for example two to four receiver subsystems, are integrated with the drill-string tubulars and are spaced apart by an amount chosen to achieve a desired depth of investigation (visualization) into the formation, which may include a depth of investigation (visualization) both around and ahead the wellbore. For example, the distance between neighboring receiver subsystems, as measured from the center point of one subsystem to the center point of a neighboring subsystem is chosen to provide a depth of investigation (imaging) up to about 500 m, up to about 450 m, up to about 400 m, up to about 350 m, up to about 300 m, up to about 250 m, up to about 200 m, up to about 150 m, or up to about 100 m around and below the wellbore. In some embodiments, the distance between adjacent receiver subsystems ranges up to about 200 m, from about 10 m to about 100 m, or from about 30 m to about 90 m. Thus, in some embodiments, a single receiver subsystem is affixed to each of two to four drill-string tubulars, for example there may be a receiver subsystem affixed to two to four adjacent drill-string tubulars.

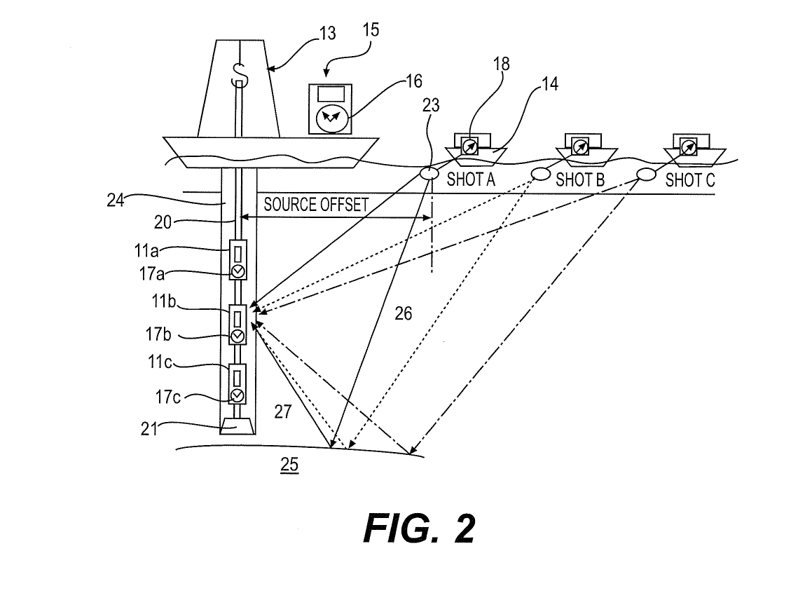

FIG. 2 depicts a marine seismic application where three receiver subsystems 11a, 11b, 11c are used. As shown, the source 23, which is an air-gun pulled by a vessel 14, is located at the surface. The drilling rig 13 is part of a floating drilling rig. The rig 13 supports the drill-string 20, which is terminated by a drill bit 21 in the wellbore 24. Although three receiver subsystems 11a, 11b, 11c are shown, a different number of receiver subsystems may be installed in the drill string 20. Each receiver subsystem is also equipped with synchronized clocks 17a, 17b, 17c versus a reference clock, which is commonly clock 16 in computer system 15 at the surface. The reference clock 16 timing could also be the GPS time. The electronics controlling the source 23 also has a synchronized clock 18. Such a clock synchronization scheme may facilitate accurately relating data records for a given shot to the start time for the records. FIG. 2 also illustrates that multiple successive shots a, b, c may be performed for a given position of the drill-string 20 in the wellbore 24. In some embodiments, the source 23 can be located at different positions (different source offsets) for these successive shots. The ray paths 26, 27 with reflection at reflector 25 are different for these shots at different offsets.

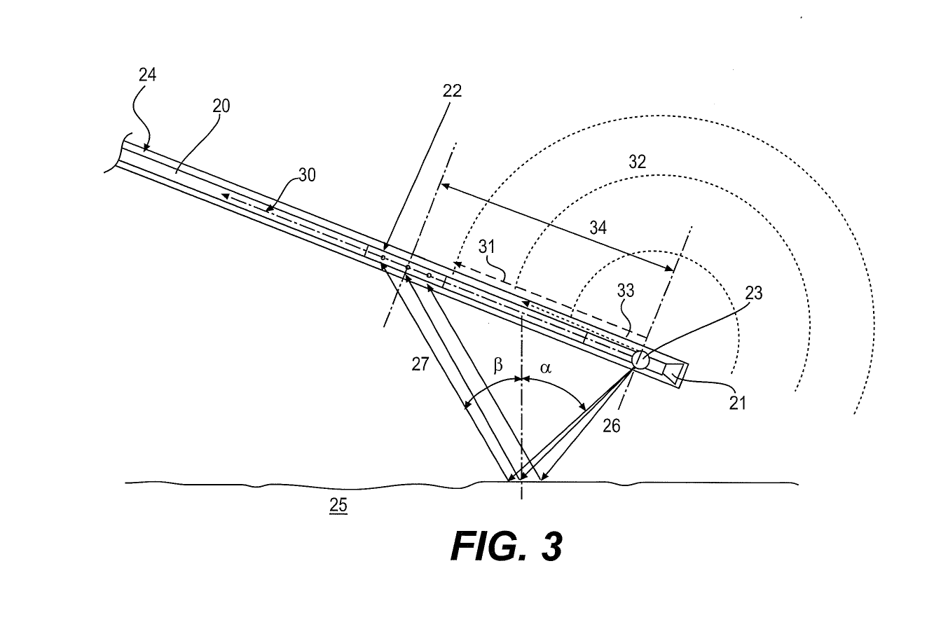

FIG. 3 shows a drill string 20 including a downhole source 23 and a receiver subsystem 22 according to this disclosure deployed in a wellbore 24. An example of a downhole source 23 which may be used to generate data that can be acquired by receiver systems according to this disclosure, is described in a co-pending application, filed concurrently herewith, also assigned to Schlumberger, and entitled: “Devices, Systems and Methods for Low Frequency Seismic Borehole Investigations.” The drill string 20 is equipped with a drill-bit 21 so that drilling can be performed. As with the embodiment of FIG. 2, multiple sub-receivers could be installed in the drill string 20. Also, the source 23 can be near the bit 21, or at the bit 21 itself, or higher in the drill-string 20 (even above some sub-receivers).

FIG. 3 further identifies various acoustic signals and principles useful in understanding various embodiments according to this disclosure. As is shown in FIG. 3, the seismic signal is typically transmitted as a spherical wave 32 expanding in the surrounding formation. Seismic signal 27 is a reflection at reflector 25 of transmitted seismic signal 26. A formation reflector is typically the interface of two layers having different acoustic properties. The reflection direction is shown according to the law of acoustic propagation: refection angle β is equal to incident angle α (the two angles are determined from the normal direction to the reflection interface). The seismic rays 26 are equivalent representation of seismic wave front 32: at each point of the wave front corresponds a ray which is perpendicular to a plane tangent to the wave front at that point. In particular, ray 31 is equivalent to ray 26, but parallel to the wellbore 24. This ray 31 propagates at the seismic velocity of the surrounding formation, creating a wave-front in the wellbore moving axially at the same velocity.

Additional waves are also shown in the figure: wave 30 is “steel arrival” wave and corresponds to the acoustic signal generated in the steel structure by the source 23 during transmission. This signal 30 travels in the steel of the drill-string 20 and BHA. It propagates at high velocities (slightly lower than the characteristic acoustic velocity in steel) and is submitted to limited attenuation. Wave 33 is tube wave generated by the source 23: this corresponds to acoustic wave travelling in the wellbore fluid at low velocity (slightly lower than the characteristic acoustic velocity of the wellbore fluid).

In some embodiments, each receiver subsystem may include multiple seismic sensors (alternatively referred to as transducers or receivers) at different axial positions. Each receiver subsystem may include different types of seismic sensors, provided that each subsystem includes at least two seismic sensors of same type. In some embodiments, the axial distance between same-type receivers ranges from about 3 m to about 10 m. In some embodiments, the axial distance between same-type receivers is chosen to facilitate the detection of same propagating wave-front arriving at the sensors of a receiver subsystem, allowing the determination of arrival times of this wave front at each sensor, and allowing the calculation of time delay between these arrival times. The delta time for adjacent sensors depends on the incident angle of this wave front on the receiver subsystem, as well as on the seismic velocity in the formation and the axial spacing between these adjacent receivers. With the simultaneous knowledge of arrival time of the wave-front to the receiver subsystem (this can be the mean value of the arrival times of this wave front on all sensors of the subsystem) and the delta-time between adjacent sensors which corresponds to the incident angle onto the receiver subsystem, it may be possible to “recognize” the mode of wave-front propagation from the source to the receivers and then either to determine certain seismic characteristics such as seismic velocity in the surrounding medium, or distance of a reflector to the borehole, or dip angle of a reflector. In some embodiments, accuracy of the determination of arrival time at a given sensor may be improved when the sensor and its associated electronics have the proper linearity, stable known phase behavior over a defined bandwidth, and reject out of band noise. In some embodiments, the AtoD convertor samples fast enough and is synchronized with the other AtoD convertors to suppress time jitter well below a desired accuracy of delta-time.

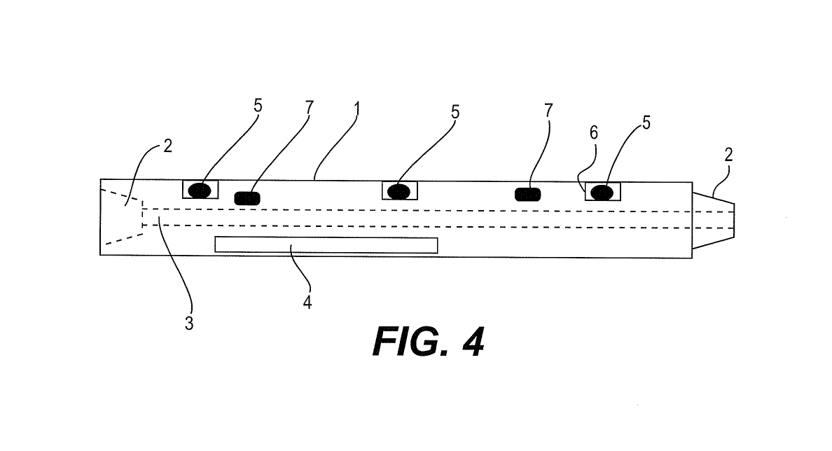

An embodiment of a receiver subsystem in accordance with the disclosure, and which could be used in the embodiments of FIGS. 2 and 3, is shown in FIG. 4. Tubular body 1 may be terminated by tapered connections 2, and may include an internal flow channel 3 enabling a fluid (e.g., drilling mud) to be pumped or moved across the receiver subsystem (alternatively referred to as “receiver sub” or “sub”). An electronic cartridge 4 for controlling data acquisition of transducers 5, 7 is also incorporated into the tubular body 1. Seismic transducers 5, 7 are distributed over the length of the tubular 1. In some embodiments, such transducers 5, 7 of a given type are distributed with substantially equal spacing between them, the spacing distance being determined based on uniform length.

The seismic transducers 5, 7 can be:
Hydrophones 5 coupled to the fluid outside the tool to detect seismic waves travelling across the surrounding formation. These hydrophones 5 may be installed in a pocket 6 for improved coupling to the external fluid and reduced coupling or de-coupling from noise travelling in the body 1. The hydrophones 5 can also be wrapped around the collar in a groove around the collar.
Geophones or accelerometers 7 coupled to the formation to detect seismic waves travelling across the surrounding formation. The coupling can be implemented directly via the body 1 of the tool or may be implemented by devices such as stabilizers and/or coupling pads, further described below.

In some embodiments, each seismic transducer is associated with an analog-to-digital (“AtoD”) convertor for data acquisition. AtoD convertors may be controlled by a control unit in the electronic cartridge 4.

In some embodiments, the receivers 5, 7 are affixed to the tubular 1 to facilitate coupling to seismic signals (e.g., 27, 31 in FIG. 3) travelling through the formation, versus seismic signal (e.g., 30 in FIG. 3) transmitted via the tubular 1 and seismic signal (e.g., 33 in FIG. 3) travelling through the wellbore. Accordingly, in some embodiments, hydrophone sensors 5 can be attached to the tubular 1 with an elastic suspension, so that the signal transmitted via the tubular 1 (e.g., wave 30 in FIG. 3) is poorly transmitted to the sensors. However, the sensors should be well coupled to the surrounding external fluid for high sensitivity to the seismic signals propagating through the fluid (such as seismic waves travelling across the formation, such as waves 31, 27 in FIG. 3, as well as the tube-wave (e.g., 33 in FIG. 3) propagating in the wellbore at low velocity. The elastic suspension can be damped to limit the effect of resonance. Rubber can be used for such suspension in the cavity 6. The hydrophones 5 and the cavity 6 can be circumferential.

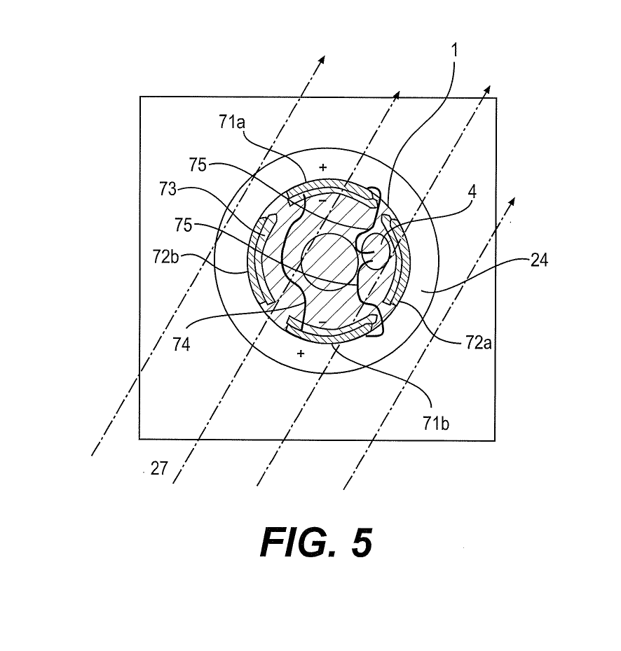

An embodiment of a hydrophone system and installation is shown in FIG. 5. Two pairs of hydrophones 71a, 71b and 72a, 72b are installed around the tubular 1. Each hydrophone is mounted to collar with a support 73 for minimizing acoustic coupling to the tubular 1. The two hydrophones of a given pair are interconnected in difference mode; in FIG. 5, “negative electrodes” of hydrophone pair 71a, 71b are interconnected together by a wire 74, while “positive electrodes” are equipped with other wires 75. The wires 75 are connected to acquisition electronics in an atmospheric chamber 4. With such interconnection, there should be no signal output when the same dynamic pressure is applied onto the pair of hydrophones 71a, 71b. However, when the pair of hydrophones 71a, 71b is subject to a difference of pressure, a signal output should be proportional to that pressure difference. When a seismic wave 27 (FIG. 3) passes at the area of this hydrophone pair 71a, 71b, a difference of pressure over a diameter of the tubular 1 may be detected. The difference of pressure should be higher for shorter wave length. At low frequency (e.g., about 10 Hz), the wave length can be approximately 300 m; with a tubular diameter of about 0.15 m, the difference of pressure can be quite low and the signal output may also be small. However, this output may be improved for higher frequency; for about 300 Hz, the wave length can be on the order of magnitude of about 10 m. Then the quarter wave length can be approximately 2.5 meters: with such a situation, the signal output may be in the range of about 10% of the amplitude of the seismic wave for that frequency. In some embodiments, additional improvements in signal detection can be achieved by performing pre-conditioning on the signal to separate it in several bandwidths:
In high frequency band, the difference may be larger in comparison to the corresponding arriving signal at the sensor. However, as acoustic attenuation along the propagation path increases with frequency, the arriving signal at the detector corresponding to the bandwidth may be small. Therefore, the output of the difference for signals in the bandwidth may be also small.
In low frequency band, the difference performed by the hydrophone pair may be low: however, the input seismic signal to these sensors may be higher as there is less attenuation across the propagation path in the formation.
   In some embodiments, by processing in multiple bandwidths, it may be possible to select the bandwidth corresponding to the largest value of the output for the difference between the two geophones.

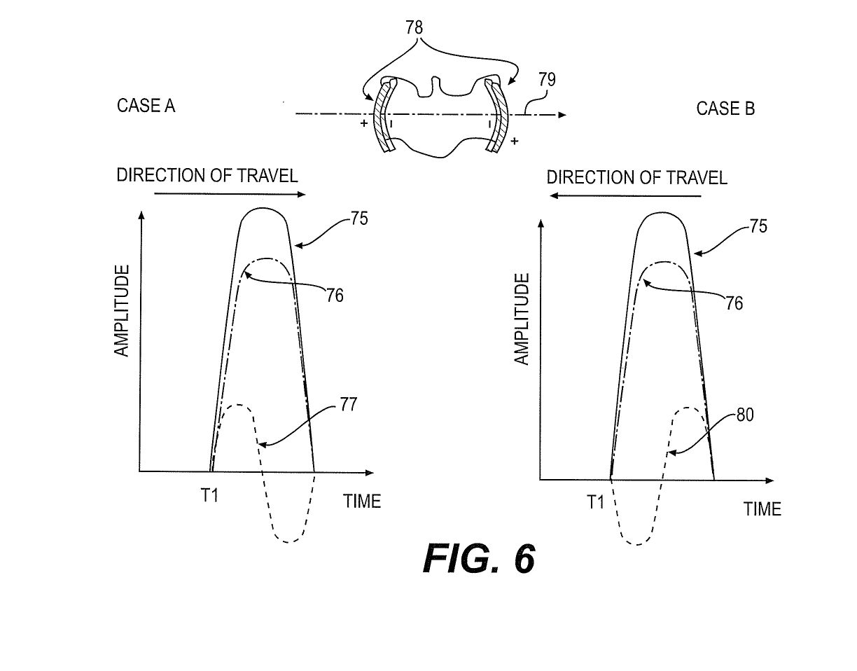

In reference to FIG. 6, the detection of the direction of travel can also be analyzed for a pair of hydrophones. As shown, hydrophone pair 78 is characterized by sensitivity axis 79. As an example, a seismic signal 75 (represented by a positive impulse) travels in a direction as shown in case A and parallel to the sensitivity axis 79 of the hydrophone pair 78. This seismic signal 75 arrives at time T1 at the tubular 1 in the wellbore 24: then a hydrophone (not shown) in the proximity of the hydrophone pair 78 has an output 76 after T1. The hydrophone pair 78 has the differential output 77. However, when the direction of travel of the seismic wave is in the opposite direction (case B of FIG. 6), the output 80 for the hydrophone pair 78 has the reverse polarity. The polarity correspondence or opposition is the detector of the direction of travel (i.e., only +/−information; no proportional information).

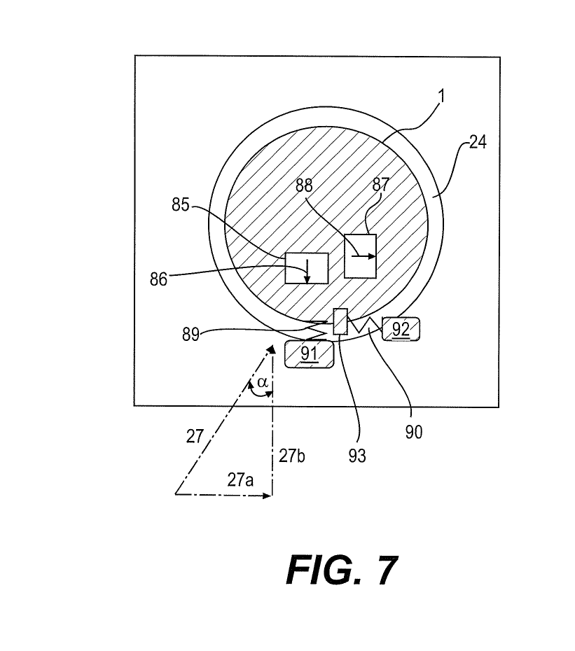

By performing this analysis for the two pairs of hydrophones installed at 90 degrees from each other, such as shown in FIG. 5, the travel direction for the seismic wave can be determined for all quadrants with a typical 45 degree resolution for tool-face. As an example, in reference to a vertical well, the wave direction can be characterized in eight quadrants as a wave arrival from North, North-East, East, South-East, South, South-West, West, North-West. Such a system may not provide high accuracy on the detection due to the low frequency of the considered signal. However, it may provide a stable method to approximate the direction. In addition, each of the hydrophones has good quality coupling to the surrounding fluid in the wellbore. By contrast, geophones attached to the metallic body of the tubular 1 may not allow such detection, as the body is too rigid (i.e., acoustic velocity is even higher), so that difference may be negligible for two geophones installed in a similar way on the tubular 1. Geophone (accelerometer) output can be sensitive to formation coupling. This is illustrated in FIG. 7. The tubular 1 holds a 2-component geophone with its two components 85, 87 having their sensitivity axes 86, 88 at 90 degrees from each other. The coupling to the geophones via the tubular 1 is represented by the spring 89, which transmits the radial component 27b of the seismic wave 27 from the local formation element 91. Spring 92 represents the coupling to the tangential component 27a of the seismic wave 27 from the local formation element 92 via the friction zone 93.

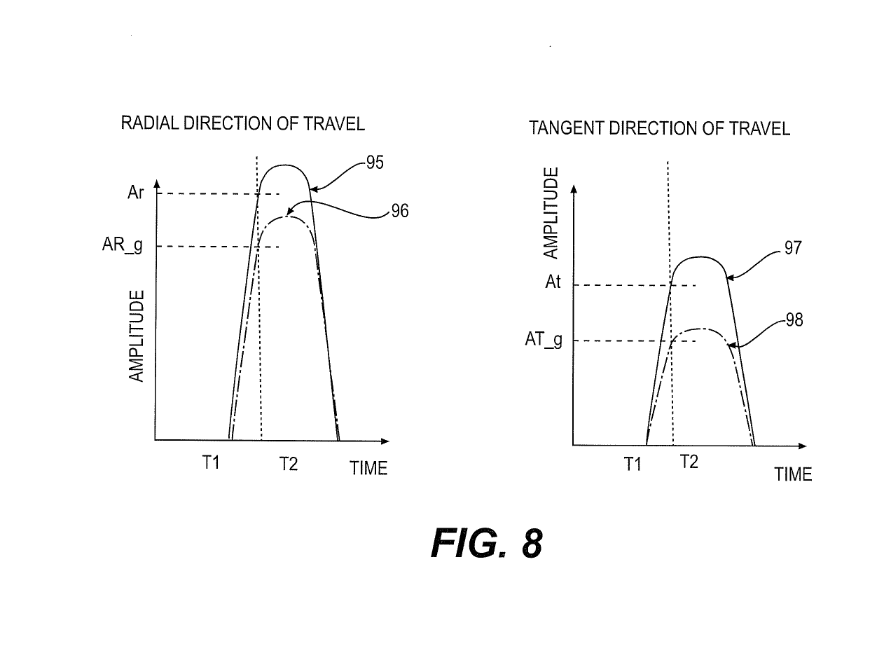

These above coupling parameters affect the signals detected by the geophone. This is described in FIG. 8. For radial direction, the projection of the seismic signal 27 in the radial direction defines the amplitude of this radial component 27b. The combination of local formation elastic deformation (represented by the coupling spring 89) and the local mass M of the tubular 1 determines the coupling parameter (sensitivity) “Coef1” for that geophone-component. So the output amplitude for geophone output is:

Ar_{—}g=Coef1Ar (1)

for any arriving signal.

This is displayed in FIG. 8; a seismic impulse arrives at the tubular at time T1. The amplitude of the radial seismic signal 95 is detected by the radial component 85 of the geophone as the measured radial signal 96. The formula (1) is true for all time (as shown for T2).

For perfect coupling, Coef1=1. Then the geophone output is maximized to the real value.

A similar observation can be made for the tangent component 27a of the seismic signal. FIG. 8 represents the output 98 of the tangent component 87 of the geophone for the arriving tangent signal 97. The following formula characterizes the sensitivity for this measurement:

At_{—}g=Coef2At (2)

for any arriving signal.

When the radial and tangent measurements are performed, the ratio (At_g/Ar_g) can be calculated for any arrival time T2:

At_{—}g/Ar_{—}g=(Coef2At)/(Coef1Ar)=Coef2/Coef1*At/Ar.

If the two coupling sensitivity coefficients are similar (or even equal to 1), then:

At_{—}g/Ar_{—}g=At/Ar

and

α=arctan(At/Ar),

where the angle α is the “tool-face” angle for the arriving seismic wave 27 onto the tubular 1. Thus the angle α can be used to determine and locate the reflector position.

In some embodiments, the available information α_{estimated} depends on the coupling sensitivity coefficient:

α_{estimated}=arctan(At_{—}g/Ar_{—}g)=arctan(Coef2/Coef1*At/Ar).

The usage of a 2C-geophone (accelerometer) installed within the tubular 1 in a plane perpendicular to the tubular axis enables the determination (or at least an estimation) of the tool-face of the arriving seismic wave 27. This tool-face angle depends on the ratio of the coupling coefficients of the 2 directions. In some embodiments, the coupling methodology may insure that these two coupling coefficients are similar (at least on average over multiple couplings and acquisition cycles). With proper methodology, the angle of the tool-face can be determined with reasonable accuracy (in some cases better than about 10 degrees). The determination of the direction of the tool-face (for example, East-to-West) can be evaluated as explained above with reference to FIGS. 5 and 6.

The usage of multi-component geophones and “multiple-pairs” hydrophones can be complementary for the full determination of the propagation direction of the seismic waves.

Regarding geophones (or accelerometers), in some embodiments, the device is configured such that these sensors can operate for any orientation versus gravity. In some embodiments, a gimballing system is used with geophone implementations so that the geophone has the correct orientation versus gravity (either vertical or horizontal). With such consideration, the receiver sub can operate versus any inclination. The geophone (accelerometer) should have a bandwidth compatible with the transmitted signal and the associated processing. In some embodiments, the signal may have a component up to about 500 Hz (or even up to about 700 Hz).

With respect to geophones (or accelerometers): in one implementation, the geophone(s) can be directly attached to the tubular 1, while gravity provides direct coupling (via direct contact) between the tubular 1 and the formation when the borehole has a slight inclination (e.g., above 4 degrees), enabling the seismic wave travelling into the formation to “enter” into the collar for detection by the geophones (or accelerometers) (for example, either 1C or 3C).

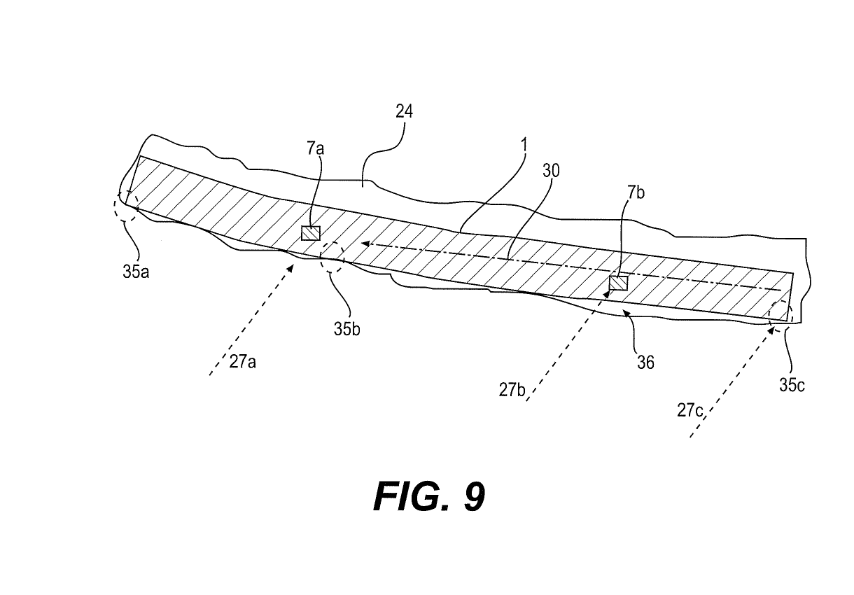

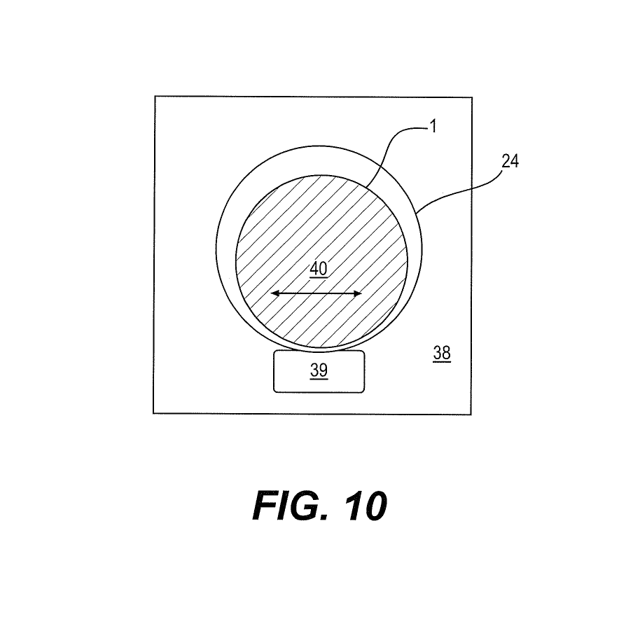

However, as illustrated in FIGS. 9 and 10, this coupling method may have some limitations:
Accurate definition of the axial contact (especially in presence of wash-out 36, or well curvature). The seismic signal 27, which can be spread locally into 27a, 27b, 27c, can reach the geophone 7b mainly by entering into the collar 1 via the contact points 35b, 35c. This corresponds to smearing of seismic signal with reduction of image quality; the geophone 7b does not only detect the seismic wave 27b, but also a mix of the waves travelling between waves 27a, 27c. It should be noted that occasionally, the smearing does not occur (i.e., for geophone 7a when contact 35b is in the vicinity of the sensor 7a allowing proper detection of the seismic ray 27a).
Resonance in the collar 1 between the points 35b, 35c with the wellbore 24. The resonance can be excited by noise in the system as well as by the seismic signal itself. The collar movements due to resonance can be detected by the geophones (accelerometers), especially when the collar is not in contact with the formation in the vicinity of the sensors (as shown with geophone 7b in FIG. 9).
Noise pick-up by geophones 7a, 7b due to coupling to the signal travelling via the collar (such as steel arrival 30)
Coupling resonance due to the mass of the collar 1 and the elastic behavior of the formation 38 in contact area 39 with the collar (FIG. 10).
Radial collar oscillation 40 in the wellbore (FIG. 10).

In some embodiments, the receiver sub includes a device to improve coupling between one or more of the geophones and the formation. For example, the device can be a stabilizer or a coupling pad, each described more fully below.

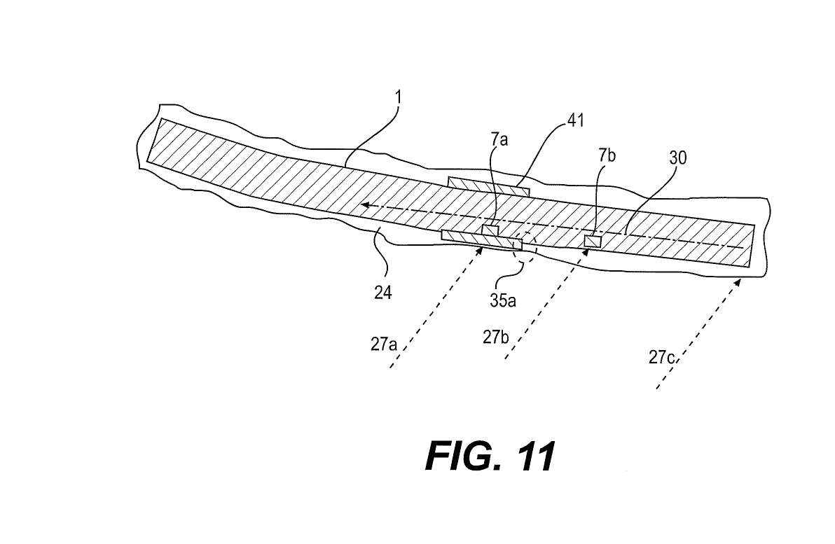

FIG. 11 illustrates geophone coupling using a stabilizer 41 on tubular 1. Geophone (accelerometer) 7a is typically installed in the body 1 at the same axial position as the stabilizer 41. The stabilizer 41 on the collar 1 defines the contact point 35a with the formation, which may limit the axial wave smearing because the geophone 7a is more sensitive to seismic ray 27a reaching the wellbore 24 at the proper axial position, while being less sensitive to other seismic rays (such as 27b and 27c). The geophone 7b, which is not adjacent to a stabilizer, is less sensitive to seismic rays travelling through the formation, while being more sensitive to signal 30 travelling axially in the tubular 1. With this additional measurement made with sensor 7b, it may be possible to reduce the perturbation generated in the measurement of geophone (accelerometer) 7a by using a proper digital filter for “noise cancellation”, using the measurement from sensor 7b as noise reference, applying the proper filter effect and subtracting the filtered value from the seismic data measured by the geophone (accelerometer) 7a; this produces an improved record of the seismic ray 27a.

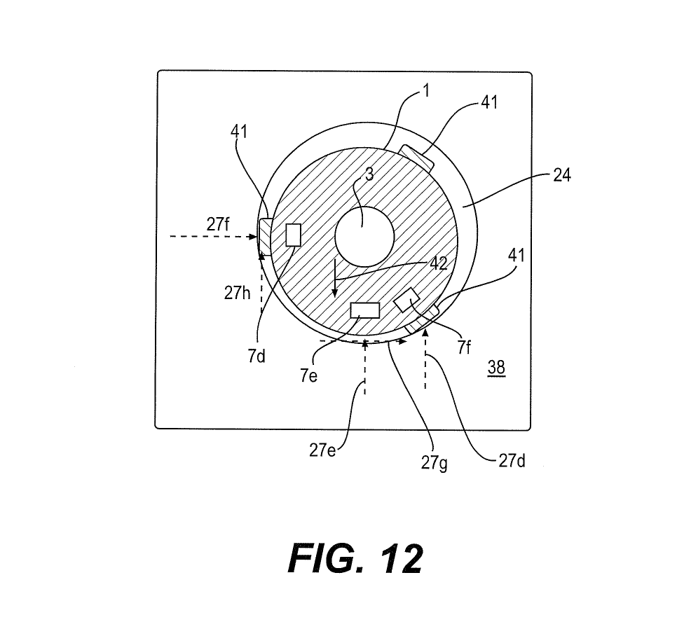

Also with straight stabilizers, the oscillation of the collar in the wellbore may be suppressed. For example, as shown in FIG. 12, tubular 1 can rest stably against the borehole 24 due to two blades of the stabilizer 41 as the gravity 42 pulls the tubular 1 against the borehole (in an inclined well—typically more than about 5 degrees of wellbore inclination).

In some embodiments, the stabilizer 41 has three straight blades, enabling two of the blades to have contact with the formation. In some embodiments, the stabilizer has four blades. Although straight blades are shown, in some embodiments, the stabilizer may have spiral blades, for example with limited coverage angle. Spiral blades may provide a good compromise between improved coupling (while no rotation) and drilling needs.

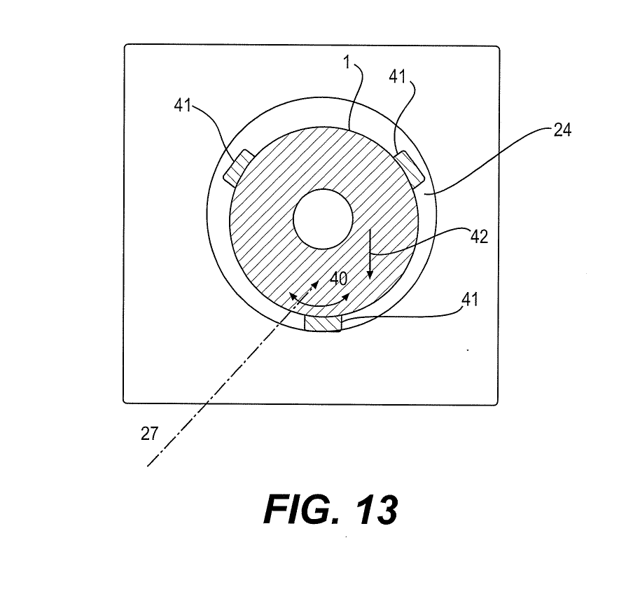

Referring now to FIG. 13, which illustrates a case of an inclined well when one stabilizer blade is below the tubular 1 and aligned with gravity 42. In that case, the tubular 1 may not lay in a stable position in the wellbore 24. The seismic wave 27 may generate oscillation 40 of the tubular 1. This oscillation 40 may be detected by the geophones inside the tubular 1 and appears as noise added over the seismic data. When the tubular 1 is equipped with a gravity sensor, (as is commonly done in MWD systems to determine the “tool-face”), it is feasible to determine the orientation (commonly called tool-face) of the tubular 1 versus the gravity vector 42. If the “tool-face” measurement indicates that the tubular 1 lies over one blade 41, the whole drill-string may be slightly rotated to eliminate this situation so that the collar is in a stable condition as shown in FIG. 12.

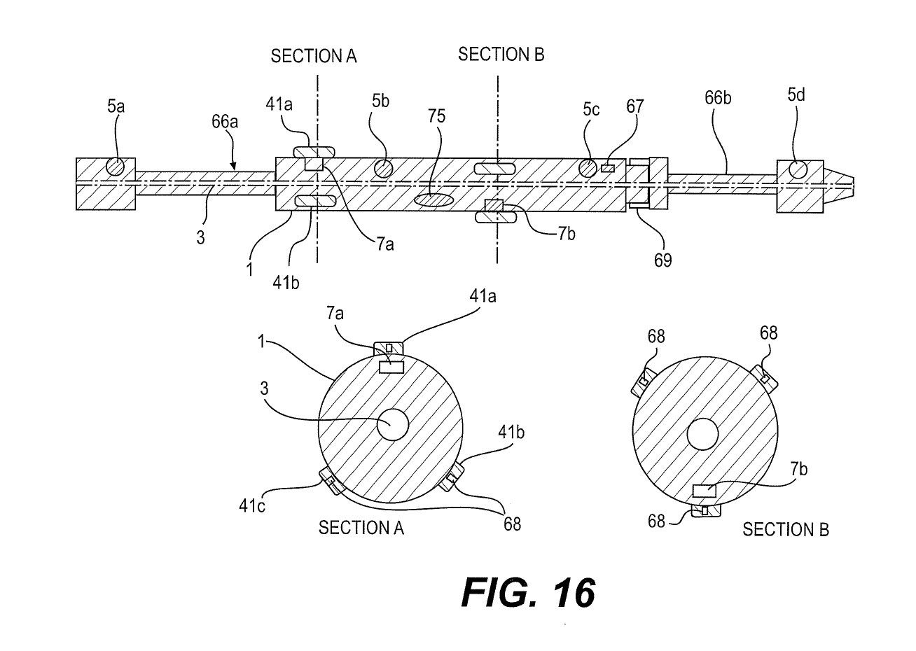

In some embodiments, as shown in FIG. 16, one or more “flex joint” sections 66a, 66b can be used to allow easy bending of the tubular 1, such that the one or more stabilizers 41a, 41b may be coupled to the formation, even in the case of a well with an irregular pattern. In some embodiments, the tubular includes at least one flex joint for each stabilizer. In some embodiments, the flex joint is part of the receiver sub. In some embodiments, the flex joint is provided at the extremity of the receiver sub.

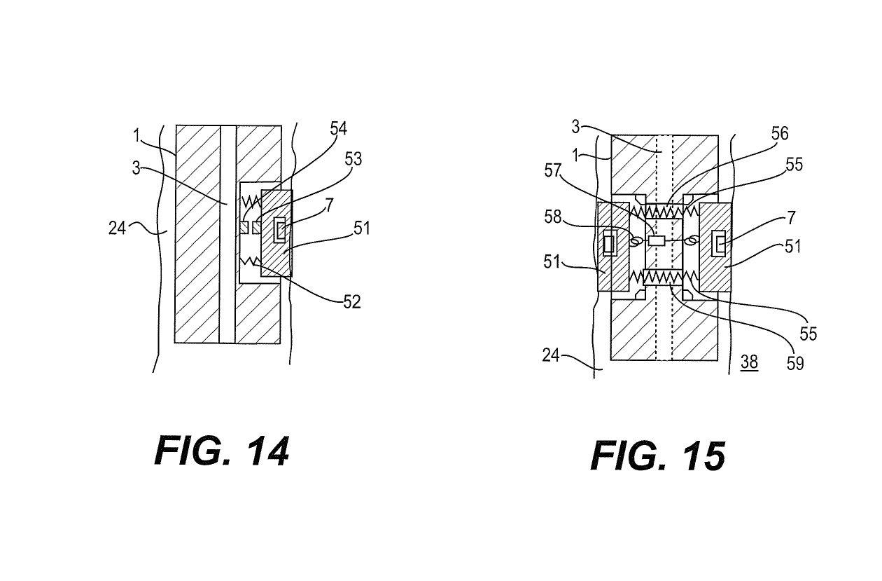

FIG. 14 illustrates one embodiment of a device, specifically a coupling pad 51, for coupling a geophone 7 to the formation. More particularly, the coupling pad 51 contains the geophone (accelerometer) 7. This assembly (the “coupling pad”) 51 is pushed against the formation via a mechanism 52, while alleviating or minimizing acoustic coupling to the tubular 1. A person of skill, reading this disclosure, would be able to select an appropriate mechanism such as one based on spring, hydraulic piston, electric mechanism to generate extension, among other possibilities. The coupling pad 51 may also include a retraction mechanism 53, 54 for retracting and locking the system. For example, with spring pushing mechanisms, the retraction mechanism 53, 54 can be constructed with a magnet (or electro-magnet). The design should be compatible with internal flow bore 3.

FIG. 15 illustrates an embodiment of a coupling pad for coupling a geophone to the formation. The coupling pad system of FIG. 15 is based on axi-symmetric geophone (accelerometer) pad configurations. According to this embodiment, the pads 51 are pushed against the formation 38 by direct pushing action between the pads. The coupling effect can be achieved by springs 55 installed inside a bore 56 perpendicular to the body 1 axis. The pads 51 can be retracted due to a mechanism 57 pulling onto the pads 51 via a hook system 58. During retraction, the pads 51 are re-located inside the tubular body 1 by locating systems (chamfers) 59. According to this construction, the pads 51 are physically released from the tubular body 1; consequently, acoustic noise (such as tube wave 30) travelling in the body 1 may not be transmitted to the pads 51.

In some of these axi-symmetric embodiments according to FIG. 15, there are three or more axi-symmetric pads 51. In some embodiments, the pads 51 are pushed against the formation 38 with minimum counter-action against the tubular 1, and the pushing mechanism can be mechanical (rigid), elastic (spring) or hydraulic. In some embodiments, the pushing system is configured in parallel with the retraction system/isolation from the collar. In some embodiments, the pushing system is configured in series with the retraction system/isolation from the collar.

The coupling force generated by the system 52 or 55 is slightly larger than the weight of the coupling pads 51 so that coupling can occur at any orientation versus gravity. The effect of the seismic wave-front passing through the coupling pads 51 induces relatively small additional acceleration (e.g., smaller than gravity), so that its effect can be neglected in defining the level of desired coupling force. The coupling force may be slightly higher than the weight of the coupling pads 51 resulting in deformation of the surface of the wellbore 24 providing a better contact surface in case of rough wellbore. In some embodiments, it may be useful to have a coupling force up to about 5 times the weight of the coupling pads 51. The pushing mechanism 52 or 55 (depending on the design) may also allow some slight tilting of the coupling pads 51 versus the tubular axis to improve the surface contact between the coupling pads 51 and the wellbore 24 when the wellbore 24 is not fully cylindrical or when the tubular 1 is not parallel or aligned to the axis of the wellbore 24.

In some embodiments, when coupling pads 51 are used, a communication method may be implemented to trigger the radial extension or retraction of the blocks before and after seismic data acquisition. In some embodiments (as shown in FIG. 16), the at least two sensors are multi-component geophones (accelerometers) 7a and 7b affixed to the tubular 1 at different axial positions identified as sections “a” and “b”. The multi-component geophones (accelerometers) 7a, 7b can be multiple single axis geophones (accelerometers) mounted at different orientations from each other (such as at 90 degrees from each other).

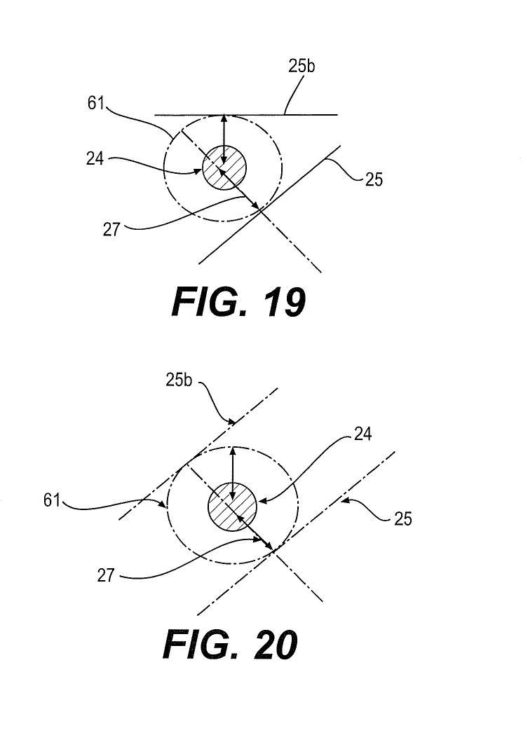

However, various receiver configurations can be used:
With 2C geophones (accelerometers), the 2 sensing components may be mounted in a plane perpendicular to the tool axis and optionally perpendicular to each other. The tool-face of the propagation plane can be determined (see FIG. 19, described in more detail below).
With 3C geophones, the propagation direction of the seismic wave can be determined: this includes the tool-face of the propagation plane and the incident angle of the seismic wave versus the tubular axis.

FIG. 16 illustrates an embodiment of a receiver subsystem for low frequency downhole seismic investigations. As shown:
The body 1 includes two flex joints 66a, 66b and a flow channel 3 extending over its full length.
The central large diameter part of the body 1 includes two centralizers (stabilizers) in sections a and b. Each centralizer has three straight blades 41a, 41b, 41c. The coupling stabilizers of sections “a” and “b” may be either aligned to each other or rotated by an angle typically corresponding to half the angle between the blades in one section. According to the latter stabilizer configuration, the tubular 1 may be more stable in the borehole, with no or little oscillation. In some embodiments, one stabilizer may be used.
In each stabilizer section, multi-component geophones (or accelerometers) are attached to the body 1 (for example, inside the atmospheric chamber containing the electronics). As shown, the geophones (accelerometers) 7a, 7b are affixed to the tubular 1 in front of the stabilizer blades. In some embodiments, the geophones (accelerometers) are placed between the two flex joints 66a, 66b to allow similar coupling quality to the wellbore, while also insuring some attenuation in steel arrival noise 30 due to the contrast of impendence in the tubular 1 from the lighter and more deformable flex joint sections 66a, 66b.
Multi-direction sensing of the seismic signals can be performed by using multi-component sensors (geophones or accelerometers): these devises can have 2 or 3 directions of sensitivity which are commonly at 90 degrees from each other. However, multi-direction sensing can also be achieved by mounting 3 single direction sensors (1C geophones or 1C accelerometers into the seismic receiver in a close vicinity from each other. These multiple 1C sensors are mounted so that their sensitivity axes are normally at 90 degrees from each other. Also, 2 sensitivity axes are preferably directly radially.
Sensors 68 are installed in (near) the stabilizer section to determine which blades are in contact with the formation. In some embodiments, each blade can include an ultrasonic pulse-echo sensor enabling determination of the stand-off from the formation. Such sensors 68 may be used for quality control of the coupling between the tubular 1 and the wellbore 24 wall via the blades of the stabilizer, allowing proper passage of seismic signal from the formation to the tubular 1 and the geophones (accelerometers) 7a, 7b.
In the extremity of the main body 1 (towards the source), a multi-component geophone (accelerometer) 67 is installed in contact with the tubular 1. This sensor facilitates determination of seismic noise travelling axially in the body (including the steel arrival 30 shown in FIG. 3). In some embodiments, more than one sensor can be used for this purpose. Hydrophones 5a, 5b, 5c, 5d are distributed over the length of the tool. Some of these hydrophones can be on the extremity of the system (on the other side of the flex joints 66a, 66b). Such a configuration enables slight extension of the receiving antenna for better seismic signal detection over a wide range of incident angles towards the wellbore and the receiver system.
A section of the tool is equipped with a sensor system 69 capable of detecting the direction of the wave propagation in the plane of propagation. In some embodiments, such a system can be two pairs of hydrophones as shown in FIG. 5.
A direction and inclination (“D&I”) system 75 is included in the tool, allowing the determination of the tool-face and inclination of the tubular 1. This additional information enables performance of a seismic data rotation into a common system of axes along the whole drill-string (such as Vertical axis, North Axis and East axis), and may improve the quality of signal processing when multiple receiver subsystems are used.

The receiver subsystems may also include an electronics cartridge 4 to perform data acquisition on all sensors while insuring that the data are sampled in a synchronized fashion. Typically the tool clock is synchronized to a reference clock to insure proper determination of the time for seismic wave arrival. Also, the electronic cartridge may allow data processing (described more fully below). In some embodiments, a clock synchronization system is affiliated with each receiving subsystem versus the transmitter in order to establish proper time referencing of the acquired data versus transmission (T0).

The clock synchronization system can be adapted as needed. For example, in one implementation, the clock synchronization is achieved via special signals travelling onto the wiring between subs (wiring for communication and optionally power feeding to these subs). This can be achieved via a downhole data bus between LWD/MWD subs, especially if the source is also included in the tubular system and connected to the same data bus. When operating with wired-drill-pipe, the clock synchronization may be performed via a long distance network including repeater subs. In that case, time delay in the cable system may also be measured to correct the delay time. This is typically performed in surface seismic system between the data concentrator and the master computer. The master node sends a synchronization frame. When received by the receiver sub, the sub returns an answering frame to the master node. The master node will receive it and measure the total time between the first frame emission and the answered frame. Knowing the lag time needed by the electronic in the master node and receiver node, the network delay time can then be calculated. The same method can be used between two successive downhole nodes (receiver or sources). As an example, a clock with controlled accuracy over a long time (such as those used in SCHLUMBERGER LWD seismic while drilling systems) can be included in the receiver sub.

The following characteristics can be included in the embodiment:
The seismic velocity is measured via the detection of the wave 31 (FIG. 3) propagating along the wellbore. This seismic velocity can be determined with high accuracy (e.g., better than about 5%). As the seismic sensor spacing is typically less than about 10 meters when only one receiver subsystem is used, the detection may be performed with an accuracy better than about 0.15 msec. This means that the signal digitalization may be performed with about 10,000 samples/sec.
The phase error of sensors of same type in the same receiver subsystem should be in the range of about 2 degrees for a signal period corresponding to the sensor separation (when considering a typical seismic velocity of about 3000 m/sec).
When multiple receiver subsystems are used, a lower sampling rate can be used for seismic velocity determination using the wave 31. For a spacing of about 50 to 100 meters, the sampling rate may be in the range of about 1000 samples/sec.
To achieve reflector separation when separated by about 10 meters, the receivers system should be able to detect seismic signal at and above about 250 Hz. This estimation is based on a criterion that the separation is feasible when the reflectors are at a minimum separation of about a quarter of a wavelength. This criterion defines the upper frequency of the band-pass filter for seismic signal. In some embodiments, the upper frequency is about 500 Hz.
The clock accuracy for driving the AtoD convertor may be better than about 50 microsec between the multiple seismic channels in the same receiver subsystem.
The clock accuracy between multiple receiver subsystems may be better than about 200 microsec to insure possible processing including data sampled at about 1000 samples/sec between different receiver subsystems.

### Data Processing.

In some embodiments according to this disclosure, the systems include a processor with machine-readable instructions for determining the distance and/or orientation of bed boundaries from the borehole. In some embodiments, the processor includes machine-readable instructions for data reduction.

FIG. 3 describes the multiple seismic waves which may be present when the seismic source is in the same well with the receiver sub. The drill-string 20 terminated by the drill bit 21 is inside the well-bore 24. The drill string 20 includes the receiver sub 22 and the seismic source 23. The seismic source could be a vibrator or “impulse” source, for example the seismic source can be as described in the co-pending application “Devices, Systems and Methods for Low Frequency Seismic Borehole Investigations” referred to previously. When a vibrator is used as a seismic source, the signal is transmitted as a sweep of frequency. Also, the total listening time when using a vibrator is typically the length of time to transmit the frequency sweep, plus the time to listen for reflection (time of travel from the source to the reflector and finally to the receivers). The transmit time can be between about 3 to 12 seconds and the listening time can extend from about 1 to 6 sec. In some embodiments with such parameters, the listening time at the receivers can extend from about 4 to 18 seconds. The received signal can be cross-correlated with the transmitted signal as a first step in processing. This permits characterization of the detected reflected signal by an approximation of the auto-correlation wavelet of the transmitted frequency sweep. For example, the cross-correlation process may reduce the length of signal for each receiver to the equivalent of the listening time (for reflector detection); this is an efficient method of reducing the total amount of data to handle (store, process or transmit) by, for example, a factor of about 3 folds (about 18 to 6 seconds for example). In some applications, cross-correlation of vibrator seismic data can be performed in the receiver subsystem.

In some embodiments, multiple shots are transmitted from a source without changing the position of the source and the receiver system, which may improve the quality of the received signal and improve the detection of the reflector. In further embodiments, the acquired data for the multiple shots can be stacked (summed) to improve the signal-to-noise ratio. After the stacking of data, the total number of data is also reduced by the summing process. In some applications, the stacking of data can be performed in the receiver subsystem.

After transmission, the main seismic wave diverges in the surrounding formation from the source in a spherical pattern 32. This diverging wave appears as a wave 31 travelling parallel to the wellbore, with a velocity corresponding to the seismic velocity in the surrounding formation.

Typically two types of waves travel across formations: compression and shear waves (with different propagation velocities). Other waves can also be generated by the excitation of the seismic source 23:
Some waves 30 propagate via the tubular itself. Several modes of propagations can be present, and may propagate at different velocities. These velocities are typically higher than the seismic velocities in the formations. They are typically the first signals detected at the receivers.
Tube waves 33 (and Rayleigh waves) propagate in the wellbore (and its interface with the formation). Their velocities are typically low, so that they arrive late.

Diverging waves 32 can be represented by spherical divergent front or by rays 26. When such rays 26 encounter a reflector 25, some signals 27 are reflected: the reflected angle (Is) is typically equal to the incident angle (α) (when no mode conversion). Some of these reflected rays will be directed towards the receiver sub and are detected by the seismic sensors.

The diverging waves 32 can also generate ray 31 travelling at the borehole wall. This wave 32 propagates at the seismic velocity of the surrounding formation and the ray 31 is detected by the sensor in the sub-receiver and allows determination of the seismic velocity in that surrounding formation. This velocity enables characterization of the formation as well as determination of the distance from the source to reflector 25.

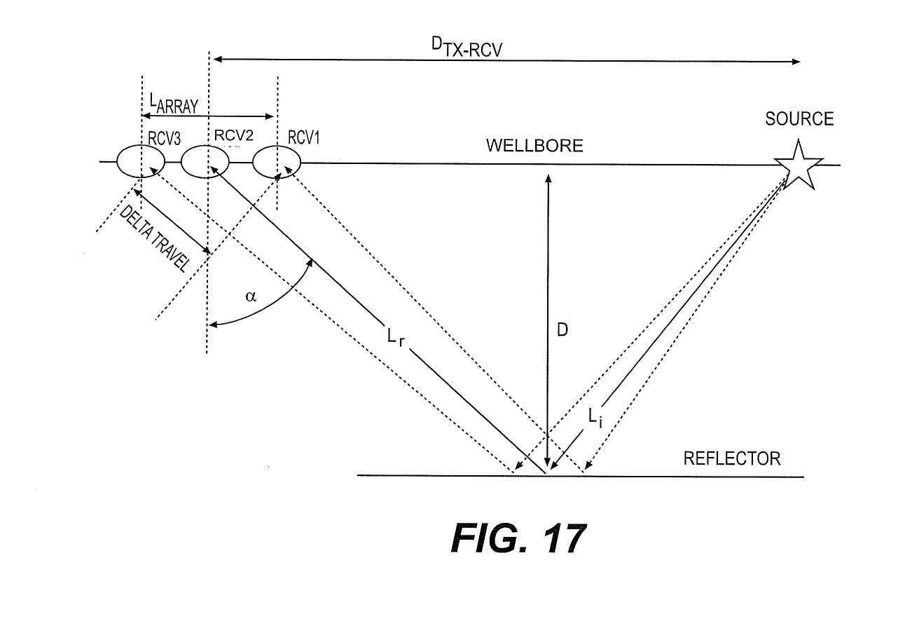

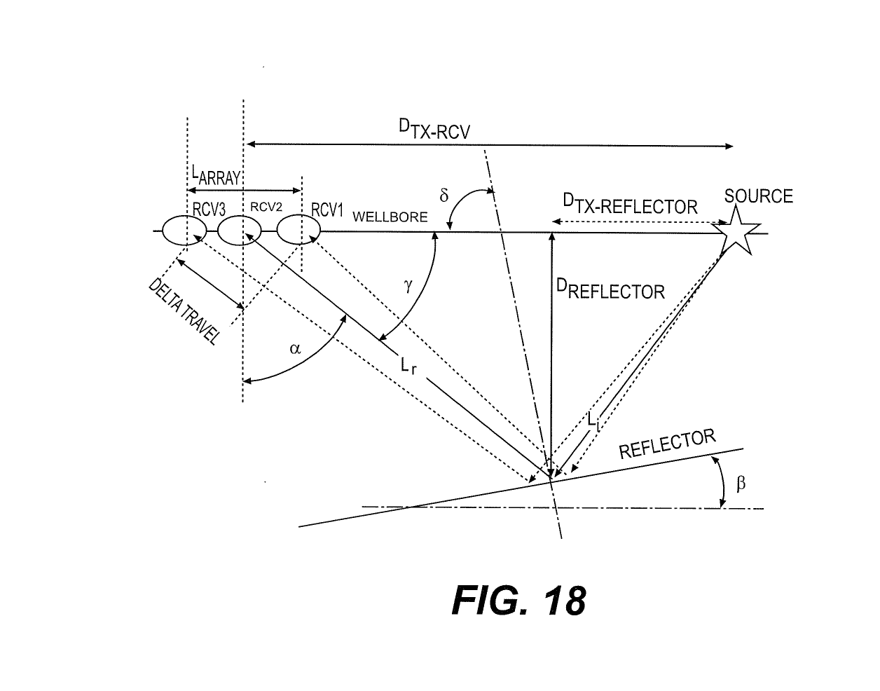

The axially distributed seismic detectors 5a, 5b, 5c, 5d (FIG. 16) of the receiver sub 22 detect these waves with time delay. As shown in FIG. 17, the time delay between the received signals depends on the seismic wave incident angle α. Also referring to FIG. 18, if the source position is known versus the receivers (such as when a downhole source is used), the distance D_{reflector} and the dip δ of the reflector in reference to the wellbore can be calculated by trigonometry. Consequently, processing based on time delay facilitates the recognition of waves travelling in the wellbore (the tube wave) or parallel to the wellbore wall, such as a front corresponding to wave diverging from a source in the same wellbore.

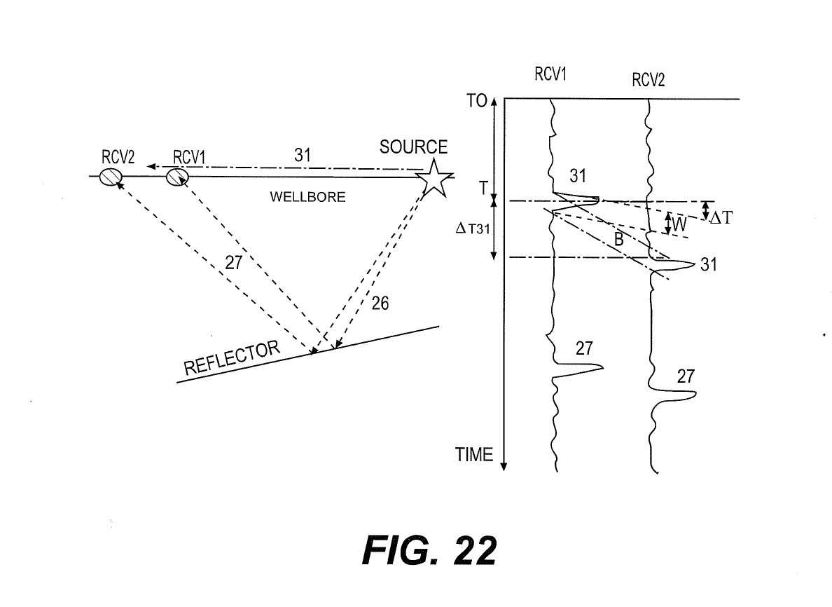

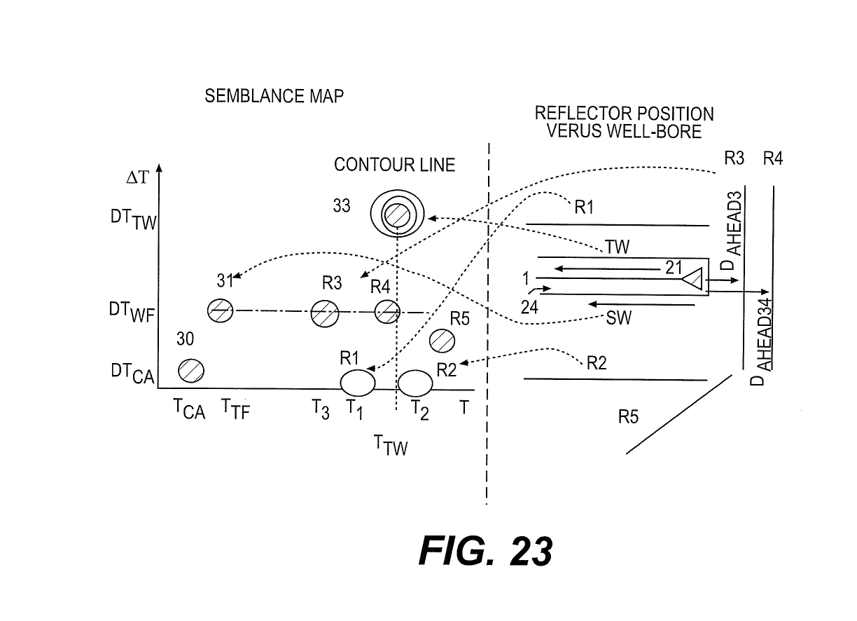

Proper processing techniques can enable a determination of this delay. In some implementations, data acquisition is performed individually for each sensor 5a, 5b, 5c, 5d such that it is possible to perform specific digital filtering to recognize the direction of propagation of the seismic wave-front. One example processing approach is based on “semblance analysis” between the recorded signals of identical seismic sensors 5a, 5b, 5c, 5d. An example is described in FIG. 22, which shows two receivers. The following wave transmission is also considered: the receivers detect the formation arrival 31 travelling parallel to the wellbore and the reflected wave 27 for a given reflector. The output of the receivers is also displayed versus time. When the wave 31 arrives, an impulse is detected at the receiver. This is also the case when the reflected signal 27 arrives at the receiver. The processing includes sliding an observation time window of a given with W. This window slides following the time axis: for each position T of the sliding window, multiple “inclinations” are considered in the shot record of all receivers. The inclination is characterized by delta-time ΔT. For the position of the sliding window characterized by T and ΔT, cross-correlation is performed between the sensor outputs. The cross-correlation factor defines the quality of the match. With the sliding window B, when the signals contained in the window for the two traces are matching well, the correlation factor is high. The cross-correlation coefficient is mapped (contour line of constant value) in a “2-dimensional” space (arrival time & shifted time (ΔT) for cross-correlation).

When considering the situation of a drill-string with a downhole source and a receiver sub having multiple sensors of same type, a more complex “semblance map” may be obtained, as typically more types of signals are present (arrival by the steel, the wellbore and multiple reflections). A description of a semblance processing analysis suitable for analyzing data acquired by receivers according to this disclosure (including for example for generating the more complex “semblance map” associated with having multiple receivers of same type) is provided in the co-pending data processing application “Data Processing Systems and Methods for Downhole Seismic Investigations” referred to previously. An example of such a “complex map” is shown in FIG. 23, and a brief description (with fuller description available in the co-pending data processing application) follows. In such maps, peak values of correlation coefficient correspond to specific wave arrivals. FIG. 23 shows the correspondence between the geometry (reflector position) and the semblance map. The reflectors (R1, R2, . . . R5) around the wellbore 24 (with tubular 1 and bit 21) are indicated in the semblance map; also the propagation signals (30, 31, 33 of FIG. 3) are included in the map. The dependence between reflector position versus the well and the peak of the contour line position on the map can be observed. As examples of T and ΔT, T may cover a range from 0 to the end of seismic record: this could be about 1, 3 or 6 sec depending on the position of the source versus the receivers, as well as the distance from the wellbore to the reflector with a downhole source. The window length for correlation between the records from adjacent receivers covers the characteristic reflected signal (or correlation wavelet): this could be 2 or 3 typical seismic cycles or mid received signal frequency. If 100 Hz is the mid frequency, the correlation window could be about 30 to 50 millisec. The shifted time (ΔT) depends mainly on the delay for the same wave front to reach the multiple receivers; this delay depends on the propagation velocity and the incidence angle. In some embodiments, the range for ΔT can extend from zero to about 3 to 5 millisec, when the distance between adjacent receivers is less than about 10 meters (for example with the seismic velocity is on the order of about 3000 m/sec).

In some embodiments, data processing can include determination (estimation) of the “tool-face” of the reflector. Referring to FIG. 19, the dip of a reflector versus the borehole may be determined thanks to the multiple receivers of one type installed in each subsystem, as already explained. But, referring to FIG. 19, the reflector 25 can be any plane 25b tangent to the circle 61 in the axial view of the well 24. This means that the reflector is located as a cone. With the usage of a 2C geophone (accelerometer) mounted in a plane perpendicular to the tool axis, it is possible to determine the tool-face of the reflector, allowing the selection of the plane 25 as the answer to the correct position of the reflector with a potential ambiguity as shown in FIG. 20. Specifically, with such sensors, the two components of the seismic vector (in the plane perpendicular to the tool axis) are detected allowing the determination of the tool-face propagation plane. In reference to FIG. 20, the detection of the tool-face for the seismic propagation may not allow resolving the “side” of the reflector versus the receiver; two tangent planes opposed to the wellbore may match that detection. The usage of a propagation sensitive design (system) as described in FIG. 5 provides a solution to this issue. Then, only one of these 2 planes is finally selected. In some embodiments, this succession of specific data processing related to a specific measurement may use a downhole seismic receiver subsystem that is equipped with adequate processing capability.

With 3C geophones (accelerometers), the entire determination of the seismic vector (and its propagation versus 3D reference) may be possible because the receiver sub knows its own orientation within the earth's reference system (vertical and azimuth) via the measurements from the D&I package (as used in MWD tool) (if available in the sub-receiver). The seismic signal can be measured by two radial geophones (accelerometers) or with 3C geophones (accelerometers), which can be rotated to be displayed in a referencing system (such as Vertical, North and East axes). The referencing in a 3D coordinate can be performed either downhole (in the receiver sub) or at the surface.

For the detection of seismic rays travelling across the formation, a single geophone (2C or 3C) may be sufficient to determine the propagation direction (only tool-face with 2C). However, the combination of multiple geophones (2C or 3C) facilitates separating these seismic rays from signal travelling axially in the collar body 1. These “body” signals excite various wave types in the tubular section which would appear mainly (in similar way) on the radial component of the 3C geophones. Additional 3C geophones (such as 67 of FIG. 16) in the section not adjacent to the stabilizer may improve the recognition of the signal 30 travelling axially in the tubular.

The usage of the measurements from 2C geophones (accelerometers) enables determination of the tool-face for the incident angle. This is illustrated in FIG. 7 and its related description. As described, the coupling quality may affect the sensitivity of the geophones. This sensitivity can be different for each component, so that the estimated tool-face for the incident angle may be affected. To limit this effect of variation of sensitivity of coupling per axis, in some embodiments, a stable coupling method is recommended. FIGS. 12, 14 and 15 illustrate embodiments of suitable stable coupling with limited variation of the coupling sensitivity.

Also, the coupling coefficients can be averaged for proper correction. In one embodiment, coupling coefficients are “averaged” for multiple sensors with same orientations. For example, the source is fired once and data is recorded and then summed on adjacent sensors. As another example averaging method, multiple recorded data set for one receiver corresponding to multiple shots, while physically moving the pipe slightly so that new coupling of the receiver is performed between each firing can be summed versus recorded time. After the summing processes for multiple geophone components (orientations), the effect of coupling is averaged so that there is less variation in the data due to coupling. Then vectorial summing can be performed between the summed (averaged) data for multiple different geophone components.

Referring to FIG. 12, with respect to 2C geophones affixed to the tubular 1 at an offset, the seismic ray 27e is detected directly by the radial component of geophone 7e, as well as the tangential component of geophone 7d. The other geophone 7f detects the same ray, but this uses some coordinate rotation between radial and tangential components. It should be noted that seismic ray 27h, 27e, 27d are equivalent as the typical seismic wave length is large in comparison to the diameter of the borehole 24.

However, the detected signals by the geophones 7d, 7e are different due to the fact that:
The tangential coupling coefficient is different from the normal coupling coefficient.
The radial geophone is also more sensitive to the signal 30 travelling via the tubular 1.
The geophone on the opposed side of the coupling is more sensitive to the collar planar resonance, which acts as a filter on the seismic signal propagating across the collar section.
   Similar logic applies for the perpendicular rays 27f, 27g, referring to the other geophones components.

In reference to the embodiment of FIG. 16, it may be possible to determine the whole signal reaching the receiver sub:
Distributed hydrophones (5a, 5b, 5c, 5d) allow the proper recognition of the seismic wave travelling in the formation and the separation from the tube wave. In some embodiments, the receiver subs include at least two geophones at two different axial positions. Additional geophones (beyond two) may improve detection and signal separation, facilitating the determination of the angle of the cones tangent to the reflectors.
The section “a” which includes a stabilizer and geophones (accelerometers) enables determination of the tool-face of the reflectors.
If two such sections (“a” and “b”, both with stabilizer & geophones) are present, the system may avoid a situation of unstable contact and may improve or insure more reliability in the seismic signal detection.
With the usage of the detectors 68 in (near) stabilizer blades, it is possible to determine which blade is in contact with the formation; the geophone corresponding to the blade which is in contact can be used to detect the seismic signal.
The sensor 67 (or more sensors—not shown) enables determination of acoustic noise travelling in the body 1. Proper digital filtering may reduce the effect of noise on the measurements from the geophones 7a, 7b in sections a and b.
The D&I package enables location of the seismic vector in the reference coordinate system.
In some embodiments, 3C geophones (accelerometers) are positioned in the section with the stabilizer in order to fully determine the direction of propagation of the seismic vectors and minimize or alleviate the difference of coupling between tangent and normal components. This usage of multiple 3G sensors also provides redundancy with the hydrophones (which in turn are less dependent on coupling variation).
In some embodiments, the geophone (accelerometer) is capable of performing acquisitions for all orientations.
In some embodiments, a sensor (or sensor system) can be used to detect the direction a wave is propagating (right to left, north to south, upwards, downwards . . . ).
In some embodiments, the geophone coupling may be improved by a mobile coupling pad as explained above.

In some embodiments, data management is part of data processing. In particular, because one or multiple receiver subs (with multiple seismic sensors) can be used in the tubular system and the seismic data may have to be acquired over several seconds, the total amount of data can be quite large. With conventional MWD telemetry, it can be difficult to transfer this amount of data to surface.

In some embodiments, the “wired-drill-pipe” or even a temporary wireline cable as telemetry system can be used to transmit all or some of the data to the surface. This technique allows transfer of several 100 kbytes per second. In some embodiments using “wired-drill-pipe” telemetry or temporary wireline cable, the seismic data can be recorded at the surface, and processing can be performed in a method similar to VSP (Vertical Seismic Profiling) as typically recorded with wireline borehole seismic. With such a telemetry configuration, the downhole receiver system is configured for compatibility with the wired-drill-pipe telemetry. Power for the system may be provided, for example, by battery (as commonly implemented in LWD) or by MWD (via the local tool-bus) if in use.

In some embodiments, for example where MWD telemetry is used with the receiver(s) to transmit data real-time, data reduction is performed prior to transmission. In some embodiments, data reduction is obtained via downhole processing to determine a few key reflectors near the seismic system for example using semblance analysis. The downhole processing can be performed on the data of each receiver to perform “beam steering” and reduce the volume of data. Alternatively, similar processing can also be performed at surface.

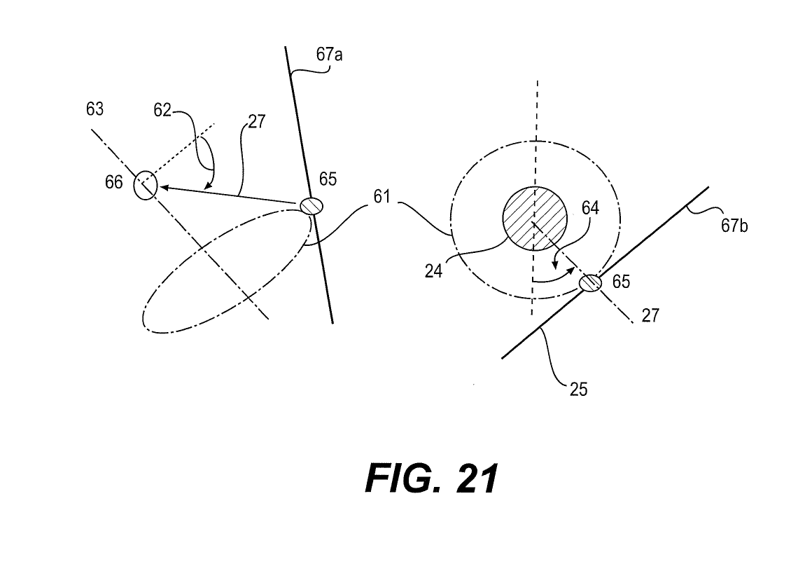

Other processing which may be implemented relates to incident angle and tool-face of the seismic waves. These angles are illustrated in FIG. 21. The wellbore axis is represented by the line 63. The seismic ray 27 reaches the receiver sub at the angle 62 in FIG. 21 (also shown as a in FIG. 18), which is the incident angle:
For a reflector parallel to the wellbore, this incident angle is 0 degree.
For a reflector perpendicular to the wellbore (i.e., in front of the bit), this incident angle is 90 degrees.

The reflector is represented by the lines 67a, 67b (corresponding to the projection in the plane view). The circle 61 represents the potential location for the reflection point of the seismic ray 27 from the reflector 67a, 67b (when not knowing the tool-face). To define (with some seismic approximation) this circle, the length of the ray 27 is obtained as follows:
Definition of the seismic velocity (Vp) in the formation: this is the ratio of separation “source to receiver” (34 in FIG. 3) divided by the arrival time T for the seismic wave front 31 (FIG. 3).
Calculation of the total path length for the rays 26+27 (in FIG. 3): this corresponds to the arrival time T of the signal to the receiver multiplied by Vp (which is obtained in the previous step). The path length is Li+Lr (as shown in FIG. 18).
The incident angle α (FIG. 18) can be determined by trigonometric calculation when the delta time and Vp are known, as this multiplication is the Delta Length.
When α, Li+Lr and D_{TX-Rcv} are known, trigonometric calculation enables obtaining Li and Lr. Lr is the length of the ray 27 (shown in FIG. 21).
The tool-face angle corresponds to angle 64, which is obtained from the data recorded in a 2C geophone installed in a plane perpendicular to the tool axis 63. This angle is measured versus a reference which can be the verticality (defined by the gravity vector).

The knowledge of incident angle 62, tool-face 64, and length of the seismic wave 27 for a given receiver position 66 in the wellbore 24 defines a single point 65 for the reflection point of the seismic ray by the reflector 67a, 67b. This point can be located in any coordinate system, including a universal coordinate system with reference to surface. This may use proper knowledge of wellbore trajectory to locate the receiver sub location 66 in that universal coordinate system, as well as the absolute tool-face of the receiver sub in the wellbore. Other methods could be used to locate the reflector versus the wellbore, using the same measurements.

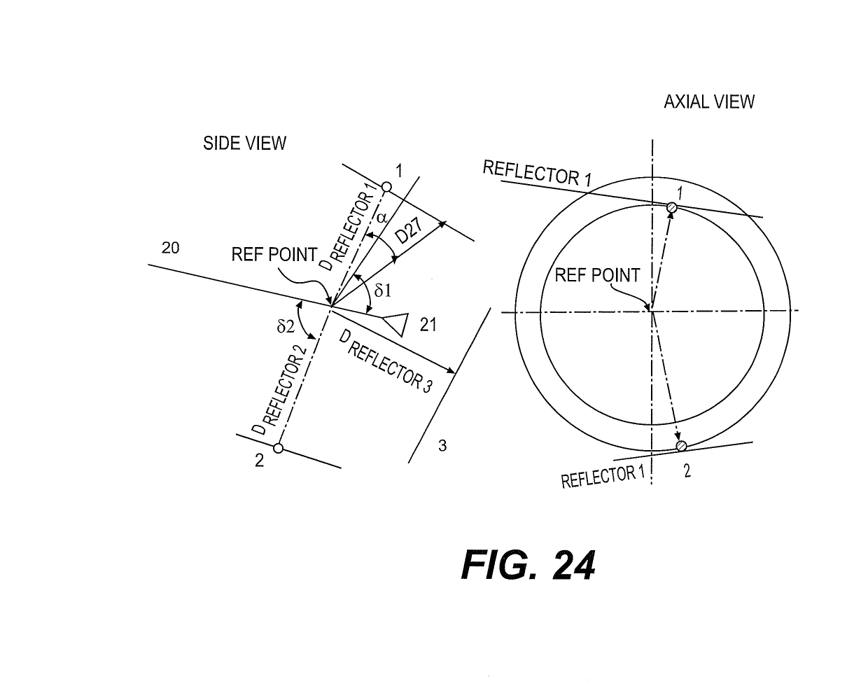

In reference to FIG. 24, the semblance processing with its contour map may position the reflector in space (“incident angle” of the reflector versus the wellbore axis & distance D27 from the wellbore as the seismic velocity near the wellbore obtained from seismic wave front 31). Then the distance can be calculated using trigonometry as the normal to the reflector or perpendicular to the wellbore trajectory.

For improved display, an averaging processing, such as described below, can be performed when multiple 2C geophones are available. In the same process, the tool-face for the arriving seismic signal may also be determined. When more than 2 multi-component geophones are available in the measurement section (section “a” or “b” of FIG. 16), the following processing can be added:
a) Determination of geophone data for processing:
   1—Determine the two blades (and associated geophone) of best contact (using sensor 68 for each blade). If needed, change the tool-face of the drill-sting in the wellbore for better stabilizer orientation; then perform a new acquisition.
   2—Determine the X-Y radial axes at 90 degree inclined by 15 deg versus the two chosen blades.
   3—For each chosen geophone, perform coordinate rotation for the two components in the plane perpendicular to the tool axis. This gives “quasi” radial and tangent rotated output for each geophone: R₁ & T₁ for geophone 1; R₂ & T₂ for geophone 2; the axial component Z1 and Z2 for each 3C geophone is unchanged.
b) Determination of tool-face and dip from “quasi radial” information (use R1, R2):
   1—Define planar amplitude: Aᵢ=(R₁ᵢ²+R₂ᵢ²)^{0.5} for all i (index of acquired samples).
   2—Define the tool-face: Tfᵢ=tan(R₁/R₂) for all i.
      3—Define average Tfavᵢ: Tfavᵢ=ΣⱼTfi*(Aᵢ²/ΣAᵢ²) for j between i−k/2 to i+k/2.
   4—Define average Z amplitude: Z12ᵢ=(Z1ᵢ+Z2ᵢ)/2.
   5—Define average total amplitude: Sᵢ=(R₁ᵢ²+R₂ᵢ²+Z₁₂ᵢ)^{0.5}.
   6—Define incident angle: αᵢ=tan(Z12ᵢ/Aᵢ).
   7—Define average incident angle: αavᵢ=Σⱼαᵢ*(Aᵢ²/ΣSᵢ²) for j between i−k/2 to i+k/2.
c) Determination of tool-face and dip from “quasi tangent” information (use T1, T2): same logic as with “quasi radial” information.
d) Determination of reflector tool-face and dip:
   1—Using the semblance graph, the arrival time for reflectors (peak of correlation) is determined
   2—Using the arrival time, select Tfav & Dipav for the corresponding time. In practice, this is performed for the “quasi tangent” and “quasi radial” information, producing Tfav_{R}, incident_angleav_{R}, Tfav_{T}, incident_angleav_{T}.

The information can be displayed in a polar plot as shown in FIG. 24. The reference is the wellbore (with its own inclination). The side view includes distance to the reflector and the incident angle, while the axial view displays the tool-face for the arriving seismic signal, as well as the distance to the reflector (this can be the projection of the true distance in the plane normal to the well axis of the true distance). Finally, data from multiple positions (receivers and/or source) can be “grouped” as in surface seismic according to common-mid-point but adapted to the downhole application. Such grouping may allow for improvement in signal-to-noise ratio and characterization of the reflector for multiple incident angles. Such processing can be performed partially downhole, as it is a convenient method to reduce the total amount of data by the data stacking performed during the application of such process.

### Methods.

The present disclosure provides methods for acquiring seismic data downhole using the systems of this disclosure. Generally, the methods include firing a seismic source and acquiring seismic data with the network of downhole receiver subsystems according to this disclosure. In some embodiments, the seismic source generates a low frequency seismic signal (for example, ranging up to about 500 Hz, or even up to about 700 Hz when including the harmonic from the transmitted signal, or from about 10 Hz to about 400 Hz, or from about 10 Hz to about 250 Hz) and the network of receiver subsystems acquires data related to the seismic signal. In some embodiments, the seismic source is downhole in the drill-string, while in other embodiments, the source is at surface. In some downhole seismic source applications, a seismic vibrator can be installed in the drill-sting for generation of frequency sweep. In some embodiments, the drilling activity is suspended during the period of seismic acquisition so that the acoustic noise is low. However, in other embodiments, the data acquisition is performed while drilling: for example, when the noise generated by the drill-bit while drilling is the seismic source. In that case, in some embodiments, the receiver subsystem(s) may be located near the bit to have a recording of the emitted noise in the near-field of emission. Such a recording can be used for cross-correlation reference in other receivers. With some drilling tools and drilling practices, the drilling noise can be quite high with a lot of specific seismic events, so that the cross-correlation is quite stable when performed with the recorded signals in other receivers.

In some embodiments, the acquired data can be processed to provide information relating to the location and orientation of bed boundaries around and ahead of the drill bit. In some embodiments, the methods include a processing step for managing the data prior to transmission to the surface, for example for reducing the volume of data prior to transmission to the surface. For example, the processing step may include a semblance analysis for determining a subset of bed boundaries. In some embodiments, the processing step includes determining the tool-face and dip of the receiving seismic ray.

The methods can have applications in a variety of seismic processes. For example, LWD VSP (similar to borehole wireline VSP or Vertical Seismic Profiling) can be performed using a system with one or multiple receiver subsystems while using a surface source. In some embodiments, the source is a downhole source.

In some embodiments, the methods can be applied to steering of a well versus a near-by existing well. In such a case, the downhole source may be installed in one well, while the receiver array can be installed in another well. In some embodiments, the source is installed in the well under drilling. The processing enables estimating the tool-face and the incident angle of the receiving seismic ray. The distance between the wells could be estimated using an estimation of seismic velocity between the wells (either obtained from surface seismic, or from downhole seismic as explained above—in that case, it may be useful to have the whole seismic system, including network of receiver subsystems and source, in the well under drilling process). In some embodiments, this well localization method can be useful for avoiding well collision, or positioning a well correctly versus another well (such as in the Steam Assisted Gravity Drainage—“SAGD”—application).

In some embodiments, the methods may be applied to a Drill String Test “DST”. The DST string may include the seismic receiver system. A surface source may be used to perform a VSP during the DST draw-down period or pressure-build period. VSP could be performed as a local 4D seismic to evaluate the variation between the DST phases. In some embodiments, downhole sources could be used to generate the seismic signals.

In some embodiments, the downhole receiver(s) can also be used to monitor the noise generated in the formation during pressure change (either during DST or normal production period). The noise may be partially due to the DARCY flow in the pore, phase change and/or change of stress in the rock due to the sudden pore pressure change. This may be quite effective in fractured carbonate as the change of facture width is probably a source of noise.

In some embodiments, the methods can be applied to fracturing operation monitoring. The seismic receiver system (and optionally along with a downhole source) can be installed in the wellbore to frac (as part of frac tubing). It can be used in similar way as for DST: mapping reflector, noise recording from formation frac propagation among other possibilities.

A number of embodiments have been described. Nevertheless it will be understood that various modifications may be made without departing from the spirit and scope of the disclosure. Accordingly, other embodiments are included as part of the disclosure and may be encompassed by the attached claims. Furthermore, the foregoing description of various embodiments does not necessarily imply exclusion. For example, “some” embodiments or “other” embodiments may include all or part of “some”, “other” and “further” embodiments within the scope of this disclosure.

Non-limiting examples of additional embodiments include:
1. A seismic receiver subsystem for downhole investigation configured to gather low frequency seismic signal suitable for estimating characteristic information chosen from: inclination of a reflector in a formation versus the drill-string tubular, the tool-face for the reflected signal arriving at the receiver subsystem, the distance between the tubular and the reflector in the formation, and combinations thereof, comprising: axially distributed hydrophones (at least two), and at least one multi-component geophone, and equipped with proper mechanical elements allowing stable acoustic coupling of the sensors to the seismic signal travelling in the surrounding formation.
2. A seismic receiver subsystem according to embodiment 1, wherein the coupling device is in the vicinity of the geophones and chosen from stabilizers, coupling pad assemblies and combinations thereof.
3. A seismic receiver subsystem according to embodiment 2, wherein the coupling stabilizer comprises three axi-symmetrical stabilizers or pads.
4. A seismic receiver subsystem according to embodiment 2, wherein the coupling stabilizer comprises activated movable pads containing the geophone and pressed against the formation.
5. A seismic receiver subsystem according to embodiment 4, wherein the movable coupling pad is attached to the main tubular body by damped elastic element, which limits the acoustic coupling to the tubular, while performing coupling to the wellbore.
6. A seismic receiver subsystem according to embodiment 2, wherein two coupling stabilizers are installed at different axial positions on the main body corresponding to the axial positions of two multi-component geophones.
7. A seismic receiver subsystem according to embodiment 1, wherein the at least two same-type receivers comprise at least two 2C or 3C geophones that are adjacent to a stabilizer or coupling pad assembly for coupling the at least two 2C or 3C geophones to the formation and at least one 2C or 3C geophone that is not adjacent to a stabilizer or coupling pad assembly.
8. A seismic receiver subsystem according to embodiment 1, wherein the drill-string tubular comprises at least one flex joint on either end of the tubular and flanking a central tool body, and a flow channel extending through the drill-string tubular; wherein the receiver subsystem further comprises one or two stabilizers comprising three or four blades, wherein the stabilizers are axially spaced-apart and are affixed to the central tool body rotationally offset from one another; wherein the at least two same-type receivers comprises at least first and second same-type receivers, and the first same-type receiver comprises a first multi-component geophone associated with a first of the two stabilizers, a second multi-component geophone associated with a second of the two stabilizers, wherein each component of the multi-component geophone is attached to the central body in front of a blade of its respective stabilizer; wherein the second same-type receiver comprises two to four hydrophones distributed over the length of the tubular.
9. A seismic receiver subsystem according to embodiment 1 or 8, equipped with sensors to provide the inclination and/or azimuth of the receiver subsystem versus fixed earth reference.
10. A seismic receiver subsystem according to any of embodiments 3, 6, 8 and 9, equipped with detectors near or in the stabilizer blades to determine the contact between the blade and the wellbore.
11. A seismic receiver subsystem according to embodiment 10, wherein ultrasonic sensors are installed in the receiver subsystem to determine the standoff between the stabilizer blade and the formation.
12. A seismic receiver subsystem according to embodiment 1, wherein at least two pairs of hydrophones are installed around the tubular at the same axial position or in close axial proximity, wherein the 2 hydrophones in a given pair are on the opposite side of the tubular and their corresponding signal will be subtracted.
13. A seismic receiver subsystem according to embodiment 12, wherein the subtracted signal from the pair of hydrophones is processed to determine the direction of the seismic wave propagation in the surrounding formation, when travelling not parallel to the wellbore.
14. A seismic receiver subsystem according to embodiment 1, wherein axial space between each same-type receiver ranges from about 3 m to about 10 m.
15. A seismic receiver subsystem according to embodiment 1, wherein each seismic signal is acquired with AtoD convertor allowing more than 5000 sample/sec and with synchronization between channels better than 100 microseconds.
16. A seismic receiver subsystem according to embodiment 1, wherein the low frequency ranges from about 10 Hz to about 500 Hz.
17. A seismic receiver subsystem according to embodiment 1, wherein the low frequency ranges from about 10 Hz to about 400 Hz.
18. A seismic receiver subsystem according to embodiment 1, wherein the low frequency ranges from about 10 Hz to about 250 Hz.
19. A seismic receiver subsystem according to embodiment 1, wherein the low frequency ranges from about 25 Hz to about 250 Hz.
20. A seismic receiver subsystem according to embodiment 1, wherein the low frequency ranges from about 8 Hz to about 100 Hz.
21. A seismic receiver subsystem according to embodiment 1, wherein the depth of investigation (imaging) ranges up to about 500 m.
22. A seismic receiver subsystem according to any of the previous embodiments, wherein the seismic signal can be generated by a downhole source or a surface source
23. A seismic receiver subsystem according to embodiment 15, wherein the acquisition of the seismic signals is performed when the drilling process is temporally suspended during the seismic signal acquisition period.
24. A seismic receiver subsystem according to any of embodiments 1 to 14, wherein the recorded signal is being generated by the drilling process itself, including the noise generated by the drill-bit during drilling action.
25. A seismic receiver system for downhole investigation configured to gather low frequency seismic signal suitable for estimating characteristic information chosen from: inclination of a reflector in the formation versus the drill-string tubular, the tool-face for the reflected signal arriving at the receiver system, distance between the tubular and the reflector in the formation, and combinations thereof, comprising: at least two, axially spaced-apart receiver subsystems, wherein each subsystem comprises at least two, same-type, axially spaced-apart receivers affixed to a drill-string tubular, wherein the axial space between each receiver subsystem measured between center points of adjacent receiver subsystem is chosen to facilitate a depth of investigation into the formation ranging up to about 500 m.
26. A seismic receiver system according to embodiment 25, wherein the axial space between each receiver within a subsystem is chosen to facilitate a resolution of at least about 20 m.
27. A seismic receiver system according to embodiment 25, wherein the at least two, axially spaced-apart receiver subsystems are according to any of embodiments 1-24.
28. A seismic receiver system according to embodiment 25, wherein the axial space between center points of receiver subsystems ranges from about 10 m to about 100 m.
29. A seismic receiver system according to embodiment 25, wherein the axial space between center points of receiver subsystems ranges from about 10 to about 90 m.
30. A seismic receiver system according to embodiment 25, wherein the axial space between center points of receiver subsystems ranges from about 30 m to about 70 m.
31. A seismic receiver system according to embodiment 25, wherein the axial space between same-type receivers is chosen to facilitate signal separation versus time and delta time.
32. A seismic receiver system according to embodiment 25, wherein the axial space between same-type receivers ranges from about 3 m to about 10 m, or from about 3 m to about 5 m.
33. A seismic receiver system according to embodiment 25, wherein the axial space between receiver subsystems ranges from about 30 m to about 70 m and the axial space between same-type receivers ranges from about 3 m to about 10 m.
34. A seismic receiver system according to embodiment 25, wherein the axial space between center points of receiver subsystems ranges from about 30 m to about 70 m and the axial space between same-type receivers ranges from about 3 m to about 5 m.
35. A seismic receiver system according to any of embodiments 25-34, wherein the axial space between center points of receiver subsystems is uniform.
36. A seismic receiver system according to embodiment 25, wherein the low frequency ranges from about 5 Hz to about 700 Hz, or from about 7 Hz to about 500 Hz, or from about 10 Hz to about 400 Hz, or from about 100 Hz to about 250 Hz.
37. A seismic receiver system according to embodiment 25, wherein the receiver system comprises two to four receiver subsystems and each of the receiver subsystems comprises at least two same-type receivers, further wherein adjacent receiver subsystems are substantially equally spaced from one another and adjacent receivers within a subsystem are substantially equally spaced from one another.
38. A seismic receiver system according to embodiment 37, wherein the at least three same-type receivers comprise three equally, axially spaced-apart hydrophones and two, axially spaced-apart geophones.
39. A seismic receiver system according to embodiment 25 or 38, wherein each receiver subsystem further comprises an electronic cartridge affixed within the tubular, and a specific AtoD converter controlled by a control unit in the electronic cartridge for each receiver subsystem.
40. A seismic receiver system according to embodiment 25, further comprising a data processor configured to cross-correlate when the source transmits a sweep of frequency and configured to stack multiple shots when the source and receivers are at the same position.
41. A seismic receiver system according to embodiment 25 or 39, further comprising a data processor configured to cross-correlate data between same-type receivers to estimate a reflector position versus wellbore.
42. A seismic receiver system according to embodiment 25, further comprising a data management system compatible with wired-drill-pipe as telemetry, a MWD (measurement while drilling) telemetry system with data reduction, or combinations thereof.
43. A seismic receiver system according to embodiment 25 or 42, wherein the system further comprises a means for clock synchronization between the receiver subsystems.
44. A seismic receiver system according to embodiment 38, further comprising a device for coupling the geophones to the formation.
45. A seismic receiver system according to embodiment 44, wherein the device is chosen from stabilizer, coupling pad assemblies and combinations thereof.
46. A seismic receiver system according to embodiment 25, wherein the at least two same-type receivers comprise at least two 2C or 3C geophones that are adjacent to a stabilizer or coupling pad assembly for coupling the at least two 2C or 3C geophones to the formation, and at least one 2C or 3C geophone that is not adjacent to a stabilizer or coupling pad assembly.
47. A seismic receiver system according to embodiment 45, wherein the device comprises three axi-symmetrical stabilizers or pads.
48. A seismic receiver system according to embodiment 25, wherein the drill-string tubular comprises at least two flex joints, one flex joint on either end of the tubular and flanking a central tool body, and a flow channel extending through the drill-string tubular; wherein the receiver system further comprises two stabilizers comprising three blades, wherein the stabilizers are axially spaced-apart and are affixed to the central tool body rotationally offset from one another; wherein the at least two same-type receivers comprise at least first and second same-type receivers, and the first same-type receiver comprises a first 3C geophone associated with a first of two stabilizers, a second 3C geophone associated with a second of two stabilizers, wherein each component of the 3C geophone is attached to the central body in front of a blade of its respective stabilizer; wherein the at least two same-type receivers further comprise a 2C geophone axially spaced-apart from the first and second 3C geophones; and the second same-type receiver comprises four hydrophones distributed over the length of the tubular.
49. A seismic receiver system according to embodiment 48, further comprising at least one sensor for determining the inclination and/or azimuth of each receiver subsystem versus a fixed earth reference.
50. A seismic receiver system according to embodiment 48 or 49, further comprising a D&I system incorporated into the tubular.
51. A method for borehole seismic investigation, comprising: using a downhole network of receiver subsystems to gather data relating to low frequency seismic signal ranging up to about 500 Hz; and estimating at least one of: inclination of a reflector in a formation versus the drill-string tubular, the tool-face for the reflected signal arriving at the receiver subsystem, distance between the drill-string tubular and the reflector in the formation and combinations thereof from the gathered data.
52. A method according to embodiment 51, wherein the network of receiver subsystems comprises two to four receiver subsystems, wherein each receiver subsystem comprises at least two, axially spaced-apart, same-type receivers, and the distance between adjacent receiver subsystems ranges from about 10 m to about 70 m and the distance between sensors within a subsystem ranges from about 3 m to about 5 m.
53. A method according to embodiment 52, wherein the gathered data is transmitted to the surface using wired-drill-pipe telemetry.
54. A method according to embodiment 51, further comprising downhole processing comprising semblance analysis to identify a desired number of reflectors before transmitting data to surface.

What is claimed is:

1. A seismic receiver subsystem for downhole investigations configured to gather low frequency seismic signal suitable for estimating a measurement chosen from: inclination of a reflector in a formation versus a drill-string tubular, a tool-face for a reflected signal arriving at the receiver subsystem, a distance between the drill-string tubular and the reflector in the formation, and combinations thereof, comprising: the drill-string tubular, at least two hydrophones axially distributed along the drill-string tubular; at least one geophone or accelerometer affixed to the drill-string tubular; and at least one coupling device for acoustically coupling the at least one multi-component geophone to the seismic signal travelling in the formation.

2. A seismic receiver subsystem according to claim 1, wherein the at least one geophone or accelerometer comprises at least one multi-component geophone or accelerometer, or a plurality of 1C geophones or accelerometers mounted with their respective axis of sensitivity oriented in different directions and in the vicinity from each other.

3. A seismic receiver subsystem according to claim 2, wherein the at least one multi-component geophone or accelerometer comprises at least two 2C or 3C geophones or accelerometers that are adjacent to the coupling device, and at least one 2C or 3C geophone or accelerometer that is not adjacent to the coupling device.

4. A seismic receiver subsystem according to claim 1, wherein the coupling device is chosen from stabilizers, coupling pad assemblies, and combinations thereof.

5. A seismic receiver subsystem according to claim 1, wherein the drill-string tubular comprises a first flex joint on one side of the drill-string collar and a second flex joint on opposite side of the drill-string tubular, the two flex joints flanking a central body of the drill-string tubular, and wherein the receiver subsystem further comprises two stabilizers having at least three blades, wherein the stabilizers are axially spaced-apart and are affixed to the central tool body rotationally offset from one another; wherein the at least one geophone or accelerometer comprises a first multi-component geophone or accelerometer associated with a first of the two stabilizers and a second multi-component geophone or accelerometer associated with a second of the two stabilizers, wherein each component of the multi-component geophones or accelerometers is attached to the central body in front of a blade of its respective stabilizer; and further wherein the at least two axially distributed hydrophones comprise two to four hydrophones distributed over a length of the drill-string tubular.

6. A seismic receiver subsystem according to claim 1, further comprising at least one sensor configured to determine inclination, azimuth, or both of the receiver subsystem versus a fixed earth reference.

7. A seismic receiver subsystem according to claim 1, wherein each pair of adjacent hydrophones has a first axial spacing therebetween, and when the at least one geophone or accelerometer is at least two geophones or accelerometer, each pair of geophones or accelerometer has substantially the same first axial spacing therebetween, wherein the first axial spacing ranges from about 3 m to about 10 m.

8. A seismic receiver subsystem according to claim 1, further comprising an AtoD convertor associated with each hydrophone and each geophone/accelerometer, wherein the AtoD convertor is configured to allow about 5000 sample/sec or more with synchronization between channels of about 100 microseconds or more.

9. A seismic receiver subsystem according to claim 1, wherein the low frequency ranges from about 10 Hz to about 500 Hz.

10. A seismic receiver system for downhole investigations configured to gather low frequency seismic signal suitable for estimating a measurement chosen from: inclination of a reflector in a formation versus a drill-string tubular, a tool-face for a reflected signal arriving at the receiver system, a distance between the drill-string tubular and the reflector in the formation, and combinations thereof, comprising: at least two, axially spaced-apart receiver subsystems, each subsystem comprising at least two, same-type, axially spaced-apart receivers affixed to the drill-string tubular, wherein an axial spacing between adjacent receiver subsystems as measured between center points of the adjacent receiver subsystems is chosen to facilitate a depth of investigation into the formation ranging up to about 500 m.

11. A seismic receiver system according to claim 10, wherein the receiver system comprises two to four receiver subsystems, wherein adjacent receiver subsystems are substantially equally spaced from one another, and adjacent receivers within a subsystem are substantially equally spaced from one another.

12. A seismic receiver system according to claim 10, further comprising a data processor configured to cross-correlate data between same-type receivers and generated by a sweep of frequency, and also configured to stack data generated by multiple shots, wherein each shot is fired from a single position of a source and the receiver system.

13. A seismic receiver system according to claim 10, further comprising a data management system for data reduction before transmission to surface that is compatible with telemetry system including either wired-drill-pipe, or a MWD (measurement while drilling) system, or combinations thereof.

14. A seismic receiver system according to claim 10, wherein the system further comprises means for clock synchronization between each of the receiver subsystems.

15. A method for borehole seismic investigations, comprising: using a downhole network of receiver subsystems to gather data relating to low frequency seismic signals ranging up to about 500 Hz; and estimating at least one of: inclination of a reflector in a formation versus a drill-string tubular, a tool-face for a reflected signal arriving at the network of receiver subsystems, a distance between the drill-string tubular and the reflector in the formation, and combinations thereof, from the gathered data.

16. A method according to claim 15, wherein the network of receiver subsystems comprises two to four receiver subsystems, wherein each receiver subsystem comprises at least two, axially-spaced apart, same-type sensors; wherein each pair of adjacent receiver subsystems is separated by a first distance as measured between center points of each receiver subsystem, and the first distance ranges from about 10 m to about 100 m; wherein each pair of adjacent sensors within a receiver substance is separated by a second distance and the second distance ranges from about 3 m to about 10 m.

17. A method according to claim 15, further comprising processing data downhole, wherein the downhole processing comprises a semblance analysis to identify a desired number of reflectors before transmitting data to surface.

18. A method according to claim 15, further comprising generating the low frequency signals using a downhole source or a surface source.

19. A method according to claim 15, further comprising gathering the low frequency data when a drilling process is temporarily suspended for seismic signal acquisition.

20. A method according to claim 15, wherein the receiver subsystem further records data generated by noise from a drill-bit during drilling action.
